(19) United States
(12) Patent Application Publication
(10) Pub. No.: US 2020/0152994 A1
(43) Pub. Date: May 14, 2020

(54) CATHODE AND LITHIUM AIR BATTERY INCLUDING THE SAME

(71) Applicant: Samsung Electronics Co., Ltd., Suwon-si (KR)

(72) Inventors: Jungock Park, Yongin-si (KR); Dongjoon Lee, Suwon-si (KR); Mokwon Kim, Suwon-si (KR); Hwiyeol Park, Hwaseong-si (KR); Heungchan Lee, Seongnam-si (KR)

(21) Appl. No.: 16/681,892

(22) Filed: Nov. 13, 2019

(30) Foreign Application Priority Data
Nov. 13, 2018 (KR) 10-2018-0139402

(51) Int. Cl. H01M 4/86; H01M 4/90; H01M 4/38; H01M 12/08

(52) U.S. Cl. CPC H01M 4/8647; H01M 4/9033; H01M 2004/027; H01M 12/08; H01M 2004/8689; H01M 4/382

(57) ABSTRACT

A cathode configured to use oxygen as a cathode active material, the cathode including: a cathode mixed conductor; and an additive disposed on the cathode mixed conductor and having a boiling temperature of about 200° C. or greater.

### CROSS-REFERENCE TO RELATED APPLICATION

This application claims priority to and the benefit of Korean Patent Application No. 10-2018-0139402, filed on Nov. 13, 2018, in the Korean Intellectual Property Office, and all the benefits accruing therefrom under 35 U.S.C. § 119, the content of which is incorporated herein in its entirety by reference.

### BACKGROUND

### 1. Field

The present disclosure relates to a cathode and a lithium air battery including the same.

### 2. Description of the Related Art

A lithium air battery uses lithium itself as an anode, and considering that there is no need to store a cathode active material in an air battery, a lithium air battery may be applicable as a high-capacity battery.

A lithium air battery has a very high theoretical specific energy of at least 3,500 Wh/kg, and this specific energy is approximately 10 times that of a lithium ion battery.

A cathode in a lithium air battery has been prepared by mixing a carbon-based conductive material, a binder, and the like. However, radicals or the like are understood to be involved in an electrochemical reaction during charge and discharge of a lithium air battery, and thus, a carbon-based conductive material, a binder, and the like can be decomposed by the radicals. Accordingly, a lithium air battery including the carbon-based conductive material cathode may easily deteriorate.

In addition, when a conductor is used with a cathode, there is a problem in that a discharge capacity of a cathode is poor.

Therefore, there is demand for a cathode for an air battery that provides improved chemical stability against radicals or the like that are generated during an electrochemical reaction and that has excellent capacity characteristics.

### SUMMARY

Provided is a cathode having excellent electronic conductivity, ionic conductivity, and capacity characteristics.

Provided is a lithium air battery including the cathode.

Additional aspects will be set forth in part in the description which follows and, in part, will be apparent from the description, or may be learned by practice of the presented embodiments.

According to an aspect of an embodiment, a cathode configured to use oxygen as a cathode active material, the cathode including: a cathode mixed conductor having an electronic conductivity of about 10⁻⁹ Siemens per centimeter to about 10⁻¹ Siemens per centimeter and an ionic conductivity of about 10⁻⁸ Siemens per centimeter to about 10⁻³ Siemens per centimeter, wherein the cathode mixed conductor includes at least one of a spinel compound, a perovskite compound, a layered compound, a garnet compound, a NASICON compound, a LISICON compound, a phosphate compound, a tavorite compound, a triplite compound, an anti-perovskite compound, a silicate compound, or a borate compound; and an additive disposed on the cathode mixed conductor and having a boiling temperature of 200° C. to about 500° C., wherein the additive includes at least one of a fluorinated organic compound, an ionic liquid, or a silicone oil.

According to another aspect of an embodiment, a lithium air battery includes: the cathode; an anode including lithium; and an electrolyte between the cathode and the anode.

Also disclosed is a method of manufacturing a cathode, the method including: providing a cathode mixed conductor having an electronic conductivity of about 10⁻⁹ Siemens per centimeter to about 10⁻¹ Siemens per centimeter and an ionic conductivity of about 10⁻⁸ Siemens per centimeter to about 10⁻³ Siemens per centimeter, wherein the cathode mixed conductor includes at least one of a spinel compound, a perovskite compound, a layered compound, a garnet compound, a NASICON compound, a LISICON compound, a phosphate compound, a tavorite compound, a triplite compound, an anti-perovskite compound, a silicate compound, or a borate compound; providing an additive having a boiling temperature of about 200° C. to about 500° C., wherein the additive includes at least one of a fluorinated organic compound, an ionic liquid, or a silicone oil; and disposing the additive on the cathode mixed conductor to manufacture the cathode.

### BRIEF DESCRIPTION OF THE DRAWINGS

These and/or other aspects will become apparent and more readily appreciated from the following description of the embodiments, taken in conjunction with the accompanying drawings in which:

FIG. 1 is a schematic diagram showing a cathode/electrolyte/anode structure of a lithium air battery;

FIG. 2 is a schematic diagram showing a cathode/electrolyte/anode structure of a lithium air battery according to an embodiment;

FIG. 3 is a graph of voltage (volts, V) versus capacity (milliampere-hours) showing discharge capacity of a lithium air battery prepared according to Comparative Example 1;

FIG. 4A is a graph of voltage (volts, V) versus capacity (milliampere-hours) showing discharge capacity of lithium air batteries prepared according to Examples 1 to 3;

FIG. 4B is a graph of voltage (volts, V) versus capacity (milliampere-hours) showing discharge capacity of a lithium air battery prepared according to Example 4;

FIG. 5 is a graph of final discharge voltage (volts, V) versus number of cycles showing a cycle-dependent discharge voltage of lithium air batteries prepared according to Examples 1 and 3;

FIG. 6A is a graph of voltage (volts, V) versus capacity (milliampere-hours) and shows a cycle-lifetime-dependent charge-discharge curve of a lithium air battery prepared according to Example 1;

FIG. 6B is a graph of voltage (volts, V) versus capacity (milliampere-hours) and a cycle-lifetime-dependent charge-discharge curve of a lithium air battery prepared according to Example 3; and

FIG. 7 is a schematic diagram showing a structure of a lithium air battery according to an embodiment.

### DETAILED DESCRIPTION

Reference will now be made in detail to embodiments, examples of which are illustrated in the accompanying drawings, wherein like reference numerals refer to like elements throughout. In this regard, the present embodiments may have different forms and should not be construed as being limited to the descriptions set forth herein. Accordingly, the embodiments are merely described below, by referring to the figures, to explain aspects. As used herein, the term “and/or” includes any and all combinations of one or more of the associated listed items.

The present inventive concept will now be described more fully with reference to the accompanying drawings, in which example embodiments are shown. The present inventive concept may, however, be embodied in many different forms, should not be construed as being limited to the embodiments set forth herein, and should be construed as including all modifications, equivalents, and alternatives within the scope of the present inventive concept; rather, these embodiments are provided so that this inventive concept will be thorough and complete, and will fully convey the effects and features of the present inventive concept and ways to implement the present inventive concept to those skilled in the art.

The terminology used herein is for the purpose of describing particular embodiments only and is not intended to be limiting. As used herein, “a”, “an,” “the,” and “at least one” do not denote a limitation of quantity, and are intended to include both the singular and plural, unless the context clearly indicates otherwise. For example, “an element” has the same meaning as “at least one element,” unless the context clearly indicates otherwise. “At least one” is not to be construed as limiting “a” or “an.” It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof. As used herein, the slash “/” or the term “and/or” includes any and all combinations of one or more of the associated listed items. “Or” means “and/or.”

In the drawings, the size or thickness of each layer, region, or element are arbitrarily exaggerated or reduced for better understanding or ease of description, and thus the present inventive concept is not limited thereto. Throughout the written description and drawings, like reference numbers and labels will be used to denote like or similar elements. It will also be understood that when an element such as a layer, a film, a region or a component is referred to as being “on” another layer or element, it can be “directly on” the other layer or element, or intervening layers, regions, or components may also be present. Although the terms “first”, “second”, etc., may be used herein to describe various elements, components, regions, and/or layers, these elements, components, regions, and/or layers should not be limited by these terms. These terms are used only to distinguish one component from another, not for purposes of limitation.

“About” or “approximately” as used herein is inclusive of the stated value and means within an acceptable range of deviation for the particular value as determined by one of ordinary skill in the art, considering the measurement in question and the error associated with measurement of the particular quantity (i.e., the limitations of the measurement system). For example, “about” can mean within one or more standard deviations, or within ±30%, 20%, 10% or 5% of the stated value.

Unless otherwise defined, all terms (including technical and scientific terms) used herein have the same meaning as commonly understood by one of ordinary skill in the art to which this disclosure belongs. It will be further understood that terms, such as those defined in commonly used dictionaries, should be interpreted as having a meaning that is consistent with their meaning in the context of the relevant art and the present disclosure, and will not be interpreted in an idealized or overly formal sense unless expressly so defined herein.

Exemplary embodiments are described herein with reference to cross section illustrations that are schematic illustrations of idealized embodiments. As such, variations from the shapes of the illustrations as a result, for example, of manufacturing techniques and/or tolerances, are to be expected. Thus, embodiments described herein should not be construed as limited to the particular shapes of regions as illustrated herein but are to include deviations in shapes that result, for example, from manufacturing. For example, a region illustrated or described as flat may, typically, have rough and/or nonlinear features. Moreover, sharp angles that are illustrated may be rounded. Thus, the regions illustrated in the figures are schematic in nature and their shapes are not intended to illustrate the precise shape of a region and are not intended to limit the scope of the present claims.

Hereinafter, a cathode according to an embodiment and a lithium air battery including the cathode will be described in further detail.

An aspect of the present disclosure provides a cathode comprising: a cathode mixed conductor having an electronic conductivity of about 10⁻⁹ Siemens per centimeter to about 10⁻¹ Siemens per centimeter and an ionic conductivity of about 10⁻⁸ Siemens per centimeter to about 10⁻³ Siemens per centimeter, wherein the cathode mixed conductor comprises at least one of a spinel compound, a perovskite compound, a layered compound, a garnet compound, a NASICON compound, a LISICON compound, a phosphate compound, a tavorite compound, a triplite compound, an anti-perovskite compound, a silicate compound, or a borate compound; and an additive disposed on the cathode mixed conductor and having a boiling temperature of about 200° C. to about 500° C., wherein the additive comprises at least one of a fluorinated organic compound, an ionic liquid, or a silicone oil.

Here, the term “cathode mixed conductor” refers to a conductor having both lithium ionic conductivity and electronic conductivity at the same time. The cathode mixed conductor of the present disclosure provides both suitable ionic conductivity and suitable electronic conductivity at the same time, and thus, a separate conductor and a separate electrolyte may be omitted from the cathode.

For example, the cathode mixed conductor may have electronic conductivity of about 1.0×10⁻⁹ Siemens per centimeter (S/cm) or greater, e.g., to about 1×10⁻¹ S/cm or to about to about 5×10⁻¹ S/cm, and an ionic conductivity of about 1.0×10⁻⁸ S/cm or greater, e.g., to about 1×10⁻³ or to about 5×10⁻³. The cathode mixed conductor may have, for example, electronic conductivity of about 1.0×10⁻⁸ S/cm or greater, e.g., to about 1×10⁻¹ S/cm or to about 5×10⁻¹ S/cm, and ionic conductivity of about 2.0×10⁻⁷ S/cm or greater, e.g., to about 1×10⁻³ or to about 5×10⁻³. The cathode mixed conductor may have, for example, electronic conductivity of about 1.0×10⁻⁷ S/cm or greater, e.g., to about 1×10⁻¹ S/cm or to about 5×10⁻¹ S/cm, and an ionic conductivity of 2.0×10⁻⁷ S/cm or greater, e.g., to about 1×10⁻³ or to about to about 5×10⁻³. The cathode mixed conductor may have, for example, electronic conductivity of about 1.0×10⁻⁶ S/cm or greater, e.g., to about 1×10⁻¹ S/cm or to about to about 5×10⁻¹ S/cm, and ionic conductivity of about 2.0×10⁻⁶ S/cm or greater, e.g., to about 1×10⁻³ or to about 5×10⁻³ S/cm.

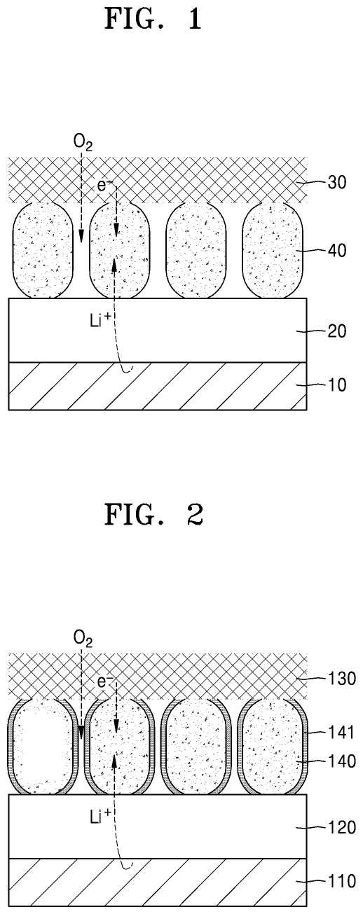

FIG. 1 is a schematic diagram showing a cathode/electrolyte/anode structure in a lithium air battery.

When a cathode including a carbon-based conductive material is used, and while not wanting to be bound by theory, it is understood that due to decomposition of carbon and electrolyte, the generation of CO₂ is observed, resulting in limitation of the charge and discharge lifetime. Therefore, as shown in FIG. 1, improved energy density and a lifetime can be provided by using, in addition to a lithium metal anode 10 and an electrolyte 20, an inorganic-based conductor 40 between the electrolyte 20 and a current collector 30.

However, using the inorganic-based conductor 40 alone may cause a high overvoltage during a charge and discharge reaction, and reaction of an electrolyte itself may occur. Reaction of an electrolyte itself may be more of a concern than a charge and discharge reaction in that the charge/discharge reaction capacity at the time of evaluating a battery will not be measured due to a problem of a reaction of an electrolyte itself.

As a result of studies that have been repeatedly carried out by the inventors of the present disclosure to increase the capacity characteristics, it was confirmed that using an additive having a boiling point of 200° C. or greater in addition to a cathode mixed conductor in a cathode for an air battery facilitated a charge and discharge reaction well.

When the boiling point of the additive is 200° C. or greater, the additive may be in a liquid state at an operating temperature (about 100° C.) at which the charge/discharge reaction of the lithium air battery occurs. In this regard, and while not wanting to be bound by theory, it is understood that the additive improves dissolution of oxygen, thereby facilitating the charge/discharge reaction.

In an embodiment, the cathode may have a composite with a core-shell structure in which the cathode mixed conductor is a core and the additive is a shell.

FIG. 2 is a schematic diagram showing a cathode/electrolyte/anode structure in a lithium air battery according to an embodiment. Referring to FIG. 2, in addition to a lithium metal anode 100 and an electrolyte 120, a mixed conductor 140, disposed between the electrolyte 120 and a current collector 130, may be used. Furthermore, it is also confirmed that an additive 141 may be provided, and in an embodiment the additive is a form of a shell around the mixed conductor 140.

That is, the additive 141 may be coated on the cathode mixed conductor 140 to provide a shell around the cathode mixed conductor 140, and accordingly, electrons and lithium ions are transferred through the cathode mixed conductor 140. Then, and while not wanting to be bound by theory, it is understood that oxygen dissolves in the additive 141 forming the shell so that a reaction may occur at an interface between the shell and the core, thereby producing a reaction product.

Here, a thickness of the shell in the composite with a core-shell structure may be in a range of about 1 nanometer (nm) to about 100 nm, about 2 nm to about 90 nm, or about 4 nm to about 80 nm. When the thickness of the shell is greater than 100 nm, a weight of the additive 141 relative to a total weight of a cathode is increased and an energy density of the lithium air battery may be reduced. When the thickness of the shell is less than 1 nm, it is difficult to achieve a desired charge/discharge reaction activation effect.

For example, the additive 141 may have a boiling point in a range of about 200° C. to about 500° C., about 225° C. to about 450° C., or about 250° C. to about 400° C.

For example, the additive 141 may have a viscosity in a range of about 5 centipoise (cp) to about 200 cp, about 10 cp to about 175 cp, or about 20 cp to about 150 cp.

When the boiling point and the viscosity of the additive 141 are satisfied within the ranges above, the additive 141 may be present in a liquid state, may be suitable for dissolving oxygen, and may activate the charge/discharge reaction of the lithium air battery.

The additive 141 is not particularly limited as long as it satisfies the above-mentioned boiling point range. For example, the additive 141 may be an organic-based additive.

For example, the additive 141 may have an oxygen solubility at 25° C. of about 1 mol/m³ or greater, e.g., about 10 mol/m³ or greater, or about 1000 mol/m³ or less.

The additive 141 is not particularly limited as long as it satisfies the above-mentioned boiling point range. For example, the additive 141 may be at least one of a fluorinated organic compound, an ionic liquid, an ether-based compound, or a silicon oil.

For example, the additive 141 may be a C11 to C20 fluorinated organic compound, such as fluorododecane.

For example, the additive 141 may be an ionic liquid. The ionic liquid may comprises at least one cation of an ammonium-based cation, a pyrrolidinium-based cation, a pyridinium-based cation, a pyrimidinium-based cation, an imidazolium-based cation, a piperidinium-based cation, a pyrazolium-based cation, an oxazolium-based cation, a pyridazinium-based cation, a phosphonium-based cation, a sulfonium-based cation, or a triazole-based cation, and at least one anion of BF₄⁻, PF₆⁻, AsF₆⁻, SbF₆⁻, AlCl₄⁻, HSO₄⁻, ClO₄⁻, CH₃SO₃⁻, CF₃CO₂⁻, N(CF₃SO₂)₂⁻, Cl⁻, Br⁻, I⁻, BF₄⁻, SO₄⁻, CF₃SO₃⁻, CF₃CO₂⁻, N(C₂F₅SO₂)₂⁻, N(C₂F₅SO₂)(CF₃SO₂)⁻, NO₃⁻, Al₂Cl₇⁻, CF₃COO⁻, CH₃COO⁻, CF₃SO₃⁻, (CF₃SO₂)₃C⁻, (CF₃CF₂SO₂)₂N⁻, (CF₃)₂PF₄⁻, (CF₃)₃PF₃⁻, (CF₃)₄PF₂⁻, (CF₃)₅PF⁻, (CF₃)₆P⁻, SF₅CF₂SO₃⁻, SF₅CHFCF₂SO₃⁻, CF₃CF₂(CF₃)₂CO⁻, (CF₃SO₂)₂CH⁻, (SF₅)₃C⁻, (O(CF₃)₂C₂(CF₃)₂O)₂PO⁻, or (CF₃SO₂)₂N—. For example, the additive 141 may be at least one of 1-ethyl-3-methylimidazolium bis(trifluoromethanesulfonyl)imide (EM), N-methyl-N-propylpiperidinium bis(trifluoromethanesulfonyl)imide (PP), N-diethyl-N-methyl-N-(2-methoxyethyl)ammonium, or N-butyl-N-methylpyrrolidinium bis(trifluoromethanesulfonyl)amide.

The additive 141 may be a perfluorinated compound. and the additive 141 may be a silicone oil. The silicone oil may be a polydimethylsiloxane, and may comprise a cyclosiloxane.

The amount of the additive 141 may be appropriately selected according to a specific surface area of the cathode. For example, the amount of the additive 141 may be in a range of about 0.01 weight percent (weight %) to about 50 weight %, about 0.02 weight % to about 45 weight %, or about 0.03 weight % to about 40 weight %, based on the total weight of the cathode. For example, the amount of the additive 141 may be in a range of about 0.03 weight % to about 40 weight %, based on the total weight of the cathode.

When the amount of the additive 141 is less than about 0.01 weight %, the additive 141 may fail to be uniformly coated so that it is difficult to achieve a desired charge/discharge reaction activation effect. When the amount of additive 141 is greater than about 50 weight %, there is a problem of lowering an energy density of the entire lithium air battery.

In an embodiment, the specific surface area of the cathode mixed conductor included in the cathode mixed conductor may be in a range of about 1 square meter per gram (m²/g) to about 100 m²/g, 2 m²/g to about 90 m²/g, or 4 m²/g to about 100 m²/g. Within this range, the lower the specific surface area of the cathode mixed conductor is, the less the content of the additive 141 to be included relative to the total weight of the cathode is. Also, the higher the specific surface area of the cathode mixed conductor is, the greater the content of the additive 141 to be included relative to the total weight of the cathode is. However, the specific surface area of the cathode mixed conductor may be adjusted as desired.

In an embodiment, the cathode mixed conductor may contain lithium.

The cathode mixed conductor may be structurally and chemically stable and contain lithium. Compared to a cathode including a carbon-based conductive material, the cathode containing lithium in the cathode mixed conductor may be inhibited from being decomposed by radicals or the like, which are accompanied by an electrochemical reaction. Accordingly, a lithium air battery including the cathode containing lithium as the cathode mixed conductor may improve charge/discharge characteristics. For example, the cathode mixed conductor may be a lithium-containing metal oxide, and in an embodiment, may be an oxide of a metal other than lithium.

The cathode mixed conductor may be, for example, a lithium ion conductor. For example, the cathode mixed conductor may be a crystalline lithium-ion conductor. When the cathode mixed conductor contains lithium and has suitable crystallinity, a migration path of lithium ions may be provided. Considering that the cathode mixed conductor is a lithium ionic conductor, the cathode may not further include a separate electrolyte.

The cathode mixed conductor may include, for example, at least one of a spinel compound, a perovskite compound, a layered compound, a garnet compound, an NASICON compound, a LISICON compound, a phosphate compound, a tavorite compound, a triplite compound, an anti-perovskite compound, a silicate compound, or a borate compound. When the cathode mixed conductor includes the foregoing compound, the cathode may be further effectively inhibited from being decomposed by radicals or the like, which are accompanied by an electrochemical reaction.

The cathode mixed conductor may include, for example, a spinel compound represented by Formula 1 or Formula 2:

Li_{1±x}M_{2±y}O_{4-δ1} Formula 1, or

Li_{4±a}M_{5±b}O_{12-δ2} Formula 2.

In Formula 1 and Formula 2, each M may independently be at least one metal element belonging to Groups 2 to 16 of the periodic table of the elements, in Formula 1, 0<x<1, 0<y<1, and 0≤δ1≤1, and in Formula 2, 0<a<2, 0.3<b<5, and 0≤δ2≤3.

δ1 and δ2 may indicate a content of an oxygen vacancy. In an aspect, 0<δ1≤1 and 0<δ2≤3.

The spinel compound may be a compound having a spinel crystal structure or a spinel-type crystal structure. “Spinel structure” as would be understood by an artisan in the solid state sciences and as is used herein means that the compound is isostructural with spinel, i.e., MgAl₂O₄.

The spinel compound may be, for example, represented by at least one of Formula 3 or Formula 4:

Li_{1±x}M_{2±y}O_{4-δ1} Formula 3, or

Li_{4±a}M_{5±b}O_{12-δ2} Formula 4.

In the Formula 3 and Formula 4, each M may independently be at least one of Ni, Pd, Pb, Fe, Ir, Co, Rh, Mn, Cr, Ru, Re, Sn, V, Ge, W, Zr, Ti, Mo, Hf, U, Nb, Th, Ta, Bi, Li, H, Na, K, Rb, Cs, Ca, Sr, Ba, Y, La, Ce, Pr, Nd, Pm, Sm, Gd, Tb, Dy, Ho, Er, Mg, Al, Si, Sc, Zn, Ga, Rb, Ag, Cd, In, Sb, Pt, Au, or Pb, 0<x<1, 0<y<1, 0≤δ≤1, 0<a<2, 0.3<b<5, and 0≤δ2≤3. δ1 and δ2 may each independently indicate a content of an oxygen vacancy.

The spinel compound may be, for example, represented by Formula 5:

Li_{4±a}Ti_{5-b}M_{c}O_{12-δ} Formula 5

In Formula 5, M may be at least one of Cr, Mg, Ca, Sr, Sc, Y, La, Ce, Pr, Nd, Sm, Eu, Gd, Tb, Dy, Ho, Er, Tm, Yb, Lu, Zr, Hf, V, Nb, Ta, Mo, W, Mn, Tc, Re, Fe, Ru, Os, Co, Rh, Ir, Ni, Pd, Pt, Cu, Ag, Au, Zn, Cd, Hg, Al, Ga, In, Tl, Ge, Sn, Pb, Sb, Bi, Po, As, Se, or Te, and in Formula 5, 0.3<a<2, 0.3<b<2, 0.3<c<2, and 0≤δ≤3. For example, 0≤δ≤2.5, 0≤δ≤2, 0≤δ≤1.5, 0≤δ≤1, or 0≤δ≤0.5. δ may indicate an oxygen vacancy content. For example, 0≤δ≤52.5, 0≤δ≤52, 0≤δ≤1.5, 0≤δ≤1, or 0≤δ≤0.5.

In the spinel compound of Formula 5, for example, a ratio of a peak intensity (Ia) at a diffraction angle 2θ of 18°±2.5° to a peak intensity (Ib) at a diffraction angle 2θ of 23.50±2.5° (Ia/Ib) for (111) crystalline plane in an X-ray diffraction (XRD) spectrum may be about 1 or less, 0.9 or less, 0.8 or less, 0.7 or less, 0.6 or less, 0.5 or less, or 0.4 or less, e.g., about 1 to about 0.001, about 8 to about 0.05, about 6 to about 0.01, or about 4 to about 0.05, when analyzed using Cu K_{α} radiation. When the spinel compound has such a peak intensity ratio, the electronic conductivity and the ionic conductivity of the spinel compound may be further improved.

The spinel compound of Formula 5 may further include, for example, another phase in addition to a phase having a spinel crystal structure. For example, the spinel compound of Formula 5 may include a phase having a spinel crystal structure of which the complex conduction belongs to a Fd-3m space group, and furthermore, may include another phase distinct from at least one of Li₂TiO₃, Gd₂Ti₂O₇, GdTiO₃, LiNbO₃, or Nb₂O₅. When the cathode mixed conductor is polycrystalline with a plurality of different phases, the electronic conductivity and the ionic conductivity of the complex conductor may be further improved.

In the spinel compound of Formula 5, a band gap between a valence band and a conduction band may be, for example, about 2.0 eV or less, about 1.8 eV or less, about 1.6 eV or less, about 1.4 eV or less, or about 1.2 eV or less, about 2.0 eV to about 0.01 eV, about 1.8 eV to about 0.05 eV, or about 1.6 eV to about 0.1 eV. When the cathode mixed conductor has such a low band gap between the valence band and the conduction band, the electron transfer from the valence band to the conduction band may be facilitated, thereby improving the electronic conductivity of the spinel compound.

In the spinel compound of Formula 5, Ti may have, for example, at least one of a trivalent oxidation number and a tetravalent oxidation number. For example, when Ti in the cathode mixed conductor has a mixed valence state having multiple oxidation numbers, a new state density function is added near the Fermi energy (Ef), and accordingly, the band gap between the valence band and the conduction band is reduced. Consequently, the electronic conductivity of the spinel compound may be further improved.

In the spinel compound of Formula 5, M may have, for example, a different oxidation number from the oxidation number of Ti. For example, when M in Formula 5 have a different oxidation number than an oxidation number of Ti in the cathode mixed conductor, a new state density function is added near the Fermi energy Ef, and accordingly, the band gap between the valence band and the conduction band is reduced. Consequently, the electronic conductivity of the spinel compound may be further improved.

When the spinel compound of Formula 5 includes an oxygen vacancy, it may provide further improved ionic conductivity. For example, when the cathode mixed conductor includes oxygen vacancy, the position of the state density function may be moved near the Fermi energy Ef, and accordingly, the band gap between the valence band and the conduction band may be reduced. Consequently, the electronic conductivity of the spinel compound may be further improved.

The spinel compound may include, for example, at least one of Li_{4±x}Ti_{5-y}Mg_{z}O_{12-δ} (0.4<x≤1, 0.4<y≤1, 0.4<z≤1, 0<δ), Li_{4±x}Ti_{5-y}Ca_{z}O_{12-δ} (0.4<x≤1, 0.4<y≤1, 0.4<z≤1, 0<δ), Li_{4±x}Ti_{5-y}Sr_{z}O_{12-δ} (0.4<x≤1, 0.4<y≤1, 0.4<z≤1, 0<δ), Li_{4±x}Ti_{5-y}Sc_{z}O_{12-δ} (0.4<x≤1, 0.4<y≤1, 0.4<z≤1, 0<δ), Li_{4±x}Ti_{5-y}Y_{z}O_{12-δ} (0.4<x≤1, 0.4<y≤1, 0.4<z≤1, 0<δ), Li_{4±x}Ti_{5-y}La_{z}O_{12-δ} (0.4<x≤1, 0.4<y≤1, 0.4<z≤1, 0<δ), Li_{4±x}Ti_{5-y}Ce_{z}O_{12-δ} (0.4<x≤1, 0.4<y≤1, 0.4<z≤1, 0<δ), Li_{4±x}Ti_{5-y}Pr_{z}O_{12-δ} (0.4<x≤1, 0.4<y≤1, 0.4<z≤1, 0<δ), Li_{4±x}Ti_{5-y}Nd_{z}O_{12-δ} (0.4<x≤1, 0.4<y≤1, 0.4<z≤1, 0<δ), Li_{4±x}Ti_{5-y}Sm_{z}O_{12-δ} (0.4<x≤1, 0.4<y≤1, 0.4<z≤1, 0<δ), Li_{4±x}Ti_{5-y}Eu_{z}O_{12-δ} (0.4<x≤1, 0.4<y≤1, 0.4<z≤1, 0<δ), Li_{4±x}Ti_{5-y}Gd_{z}O_{12-δ} (0.4<x≤1, 0.4<y≤1, 0.4<z≤1, 0<δ), Li_{4±x}Ti_{5-y}Tb_{z}O_{12-δ} (0.4<x≤1, 0.4<y≤1, 0.4<z≤1, 0<δ), Li_{4±x}Ti_{5-y}Dy_{z}O_{12-δ} (0.4<x≤1, 0.4<y≤1, 0.4<z≤1, 0<δ), Li_{4±x}Ti_{5-y}Ho_{z}O_{12-δ} (0.4<x≤1, 0.4<y≤1, 0.4<z≤1, 0<δ), Li_{4±x}Ti_{5-y}Er_{z}O_{12-δ} (0.4<x≤1, 0.4<y≤1, 0.4<z≤1, 0<δ), Li_{4±x}Ti_{5-y}Tm_{z}O_{12-δ} (0.4<x≤1, 0.4<y≤1, 0.4<z≤1, 0<δ), Li_{4±x}Ti_{5-y}Yb_{z}O_{12-δ} (0.4<x≤1, 0.4<y≤1, 0.4<z≤1, 0<δ), Li_{4±x}Ti_{5-y}Lu_{z}O_{12-δ} (0.4<x≤1, 0.4<y≤1, 0.4<z≤1, 0<δ), Li_{4±x}Ti_{5-y}Zr_{z}O_{12-δ} (0.4<x≤1, 0.4<y≤1, 0.4<z≤1, 0<δ), Li_{4±x}Ti_{5-y}Hf_{z}O_{12-δ} (0.4<x≤1, 0.4<y≤1, 0.4<z≤1, 0<δ), Li_{4±x}Ti_{5-y}V_{z}O_{12-δ} (0.4<x≤1, 0.4<y≤1, 0.4<z≤1, 0<δ), Li_{4±x}Ti_{5-y}Nb_{z}O_{12-δ} (0.4<x≤1, 0.4<y≤1, 0.4<z≤1, 0<δ), Li_{4±x}Ti_{5-y}Ta_{z}O_{12-δ} (0.4<x≤1, 0.4<y≤1, 0.4<z≤1, 0<δ), Li_{4±x}Ti_{5-y}Mo_{z}O_{12-δ} (0.4<x≤1, 0.4<y≤1, 0.4<z≤1, 0<δ), Li_{4±x}Ti_{5-y}W_{z}O_{12-δ} (0.4<x≤1, 0.4<y≤1, 0.4<z≤1, 0<δ), Li_{4±x}Ti_{5-y}Mn_{z}O_{12-δ} (0.4<x≤1, 0.4<y≤1, 0.4<z≤1, 0<δ), Li_{4±x}Ti_{5-y}Tc_{z}O_{12-δ} (0.4<x≤1, 0.4<y≤1, 0.4<z≤1, 0<δ), Li_{4±x}Ti_{5-y}Re_{z}O_{12-δ} (0.4<x≤1, 0.4<y≤1, 0.4<z≤1, 0<δ), Li_{4±x}Ti_{5-y}Fe_{z}O_{12-δ} (0.4<x≤1, 0.4<y≤1, 0.4<z≤1, 0<δ), Li_{4±x}Ti_{5-y}Ru_{z}O_{12-δ} (0.4<x≤1, 0.4<y≤1, 0.4<z≤1, 0<δ), Li_{4±x}Ti_{5-y}Os_{z}O_{12-δ} (0.4<x≤1, 0.4<y≤1, 0.4<z≤1, 0<δ), Li_{4±x}Ti_{5-y}Co_{z}O_{12-δ} (0.4<x≤1, 0.4<y≤1, 0.4<z≤1, 0<δ), Li_{4±x}Ti_{5-y}Rh_{z}O_{12-δ} (0.4<x≤1, 0.4<y≤1, 0.4<z≤1, 0<δ), Li_{4±x}Ti_{5-y}Ir_{z}O_{12-δ} (0.4<x≤1, 0.4<y≤1, 0.4<z≤1, 0<δ), Li_{4±x}Ti_{5-y}Ni_{z}O_{12-δ} (0.4<x≤1, 0.4<y≤1, 0.4<z≤1, 0<δ), Li_{4±x}Ti_{5-y}Pd_{z}O_{12-δ} (0.4<x≤1, 0.4<y≤1, 0.4<z≤1, 0<δ), Li_{4±x}Ti_{5-y}Pt_{z}O_{12-δ} (0.4<x≤1, 0.4<y≤1, 0.4<z≤1, 0<δ), Li_{4±x}Ti_{5-y}Cu_{z}O_{12-δ} (0.4<x≤1, 0.4<y≤1, 0.4<z≤1, 0<δ), Li_{4±x}Ti_{5-y}Ag_{z}O_{12-δ} (0.4<x≤1, 0.4<y≤1, 0.4<z≤1, 0<δ), Li_{4±x}Ti_{5-y}Au_{z}O_{12-δ}(0.4<x≤1, 0.4<y≤1, 0.4<z≤1, 0<δ), Li_{4±x}Ti_{5-y}ZnO_{12-δ} (0.4<x≤1, 0.4<y≤1, 0.4<z≤1, 0<δ), Li_{4±x}Ti_{5-y}Cd_{z}O_{12-δ} (0.4<x≤1, 0.4<y≤1, 0.4<z≤1, 0<δ), Li_{4±x}Ti_{5-y}Hg_{z}O_{12-δ} (0.4<x≤1, 0.4<y≤1, 0.4<z≤1, 0<δ), Li_{4±x}Ti_{5-y}Al_{z}O_{12-δ} (0.4<x≤1, 0.4<y≤1, 0.4<z≤1, 0<δ), Li_{4±x}Ti_{5-y}Ga_{z}O_{12-δ} (0.4<x≤1, 0.4<y≤1, 0.4<z≤1, 0<δ), Li_{4±x}Ti_{5-y}In_{z}O_{12-δ} (0.4<x≤1, 0.4<y≤1, 0.4<z≤1, 0<δ), Li_{4±x}Ti_{5-y}Tl_{z}O_{12-δ} (0.4<x≤1, 0.4<y≤1, 0.4<z≤1, 0<δ), Li_{4±x}Ti_{5-y}Ge_{z}O_{12-δ} (0.4<x≤1, 0.4<y≤1, 0.4<z≤1, 0<δ), Li_{4±x}Ti_{5-y}Sn_{z}O_{12-δ} (0.4<x≤1, 0.4<y≤1, 0.4<z≤1, 0<δ), Li_{4±x}Ti_{5-y}Pb_{z}O_{12-δ} (0.4<x≤1, 0.4<y≤1, 0.4<z≤1, 0<δ), Li_{4±x}Ti_{5-y}Sb_{z}O_{12-δ} (0.4<x≤1, 0.4<y≤1, 0.4<z≤1, 0<δ), Li_{4±x}Ti_{5-y}Bi_{z}O_{12-δ} (0.4<x≤1, 0.4<y≤1, 0.4<z≤1, 0<δ), Li_{4±x}Ti_{5-y}Po_{z}O_{12-δ} (0.4<x≤1, 0.4<y≤1, 0.4<z≤1, 0<δ), Li_{4±x}Ti_{5-y}As_{z}O_{12-δ} (0.4<x≤1, 0.4<y≤1, 0.4<z≤1, 0<δ), Li_{4±x}Ti_{5-y}Se_{z}O_{12-δ} (0.4<x≤1, 0.4<y≤1, 0.4<z≤1, 0<δ), or Li_{4±x}Ti_{5-y}Te_{z}O_{12-δ} (0.4<x≤1, 0.4<y≤1, 0.4<z≤1, 0<δ). In an aspect, 0<<53, or 0<<52, 0<≤1.

The spinel compound may be, for example, LiMn₂O₄, LiTiNbO₄, Li₄Ti₅O₁₂, Li₄Mn₅O₁₂, Li_{4.5}Ti_{4.5}Gd_{0.5}O₁₂, or the like, but is not limited thereto. Any suitable material including lithium and available as a spinel compound in the art may be used.

The spinel compound may have, for example, the electronic conductivity of 1.0×10⁻⁹ S/cm or greater and the ionic conductivity of 1.0×10⁻⁸ S/cm or greater.

The electronic conductivity of the spinel compound may be, for example, about 5.0×10⁻⁹ S/cm or greater, about 1.0×10⁻⁸ S/cm or greater, about 5.0×10⁻⁸ S/cm or greater, about 1.0×10⁻⁷ S/cm or greater, about 5.0×10⁻⁷ S/cm or greater, about 1.0×10⁻⁶ S/cm or greater, about 5.0×10⁻⁶ S/cm or greater, about 1.0×10⁻⁵ S/cm or greater, about 5.0×10⁻⁵ S/cm or greater, about 1.0×10⁻⁴ S/cm or greater, about 5.0×10⁻⁴ S/cm or greater, or about 1.0×10⁻³ S/cm or greater, about 5.0×10⁻⁹ S/cm to about 10⁻¹ S/cm, about 1.0×10⁻⁸ S/cm to about 10⁻¹ S/cm, about 5.0×10⁻⁸ S/cm to about 10⁻¹ S/cm, about 1.0×10⁻⁷ S/cm to about 10⁻¹ S/cm, about 5.0×10⁻⁷ S/cm to about 10⁻¹ S/cm, about 1.0×10⁻⁶ S/cm to about 10⁻¹ S/cm, about 5.0×10⁻⁶ S/cm to about 10⁻¹ S/cm, about 1.0×10⁻⁵ S/cm to about 10⁻¹ S/cm, about 5.0×10⁻⁵ S/cm to about 10⁻¹ S/cm, about 1.0×10⁻⁴ S/cm to about 10⁻¹ S/cm, about 5.0×10⁻⁴ S/cm to about 10⁻¹ S/cm, or about 1.0×10⁻³ S/cm to about 10⁻¹ S/cm. When the spinel compound has such high electronic conductivity, a cathode including the spinel compound and a lithium air battery including the cathode may each have reduced internal resistance.

The ionic conductivity of the spinel compound may be, for example, about 5.0×10⁻⁸ S/cm or greater, about 1.0×10⁻⁷ S/cm or greater, about 5.0×10⁻⁷ S/cm or greater, about 1.0×10⁻⁶ S/cm or greater, about 5.0×10⁻⁶ S/cm or greater, or about 1.0×10⁻⁵ S/cm or greater, about 5.0×10⁻⁸ S/cm to about 10⁻³ S/cm, about 1.0×10⁻⁷ S/cm to about 10⁻³ S/cm, about 5.0×10⁻⁷ S/cm to about 10⁻³ S/cm, about 1.0×10⁻⁶ S/cm to about 10⁻³ S/cm, about 5.0×10⁻⁶ S/cm to about 10⁻³ S/cm, or about 1.0×10⁻⁵ S/cm to about 10⁻³ S/cm. When the spinel compound has such high ionic conductivity, a cathode including the spinel compound and a lithium battery including the cathode may each have further reduced internal resistance.

The cathode mixed conductor may include, for example, a perovskite compound represented by Formula 6:

LiₓA_{y}G_{z}O_{3-δ} Formula 6

In Formula 6, A and G may each independently be at least one metal element belonging to Groups 2 to 16 of the Periodic Table of Elements, 0<x<1, 0<y<1, 0<x+y≤1, 0<z≤1.5, and 0≤δ≤1.5. δ may indicate an oxygen vacancy content.

The perovskite compound may be a compound having a perovskite crystal structure or a perovskite-type crystalline structure. A “perovskite structure,” as would be understood by an artisan in the solid state sciences, and as is used herein, means that the compound is isostructural with perovskite, i.e., CaTiO₃.

The perovskite compound may be, for example, represented by Formula 7:

LiₓA_{y}G_{z}O_{3-δ} Formula 7.

In Formula 7, A may include at least one of H, Na, K, Rb, Cs, Ca, Sr, Ba, Y, La, Ce, Pr, Nd, Pm, Sm, Gd, Tb, Dy, Ho, and Er, G may include at least one of Ti, Pd, Pb, Fe, Ir, Co, Rh, Mn, Cr, Ru, Re, Sn, V, Ge, W, Zr, Ti, Mo, Hf, U, Nb, Th, Ta, Bi, Li, H, Na, K, Rb, Cs, Ca, Sr, Ba, Y, La, Ce, Pr, Nd, Pm, Sm, Gd, Tb, Dy, Ho, Er, Mg, Al, Si, Sc, Zn, Ga, Rb, Ag, Cd, In, Sb, Pt, Au, or Pb, 0.2<x≤0.7, 0<y≤0.7, 0<x+y<1, 0<z≤1.2, and 0≤δ≤1.2. δ indicates an oxygen vacancy content.

The perovskite compound may be, for example, represented by Formula 8:

LiₓA_{y}G_{z}O_{3-δ} Formula 8.

In Formula 8, A may include at least one of La, Ce, Pr, Gd, Ca, Sr, or Ba, M may include at least one of Ti, Mn, Ni, Ru, Cr, Co, Ti, Ru, Ir, Fe, Pd, Pb, Rh, Sn, V, Re, Ge, W, Zr, Mo, Nb, Ta, Hf, or Bi, δ indicates an oxygen vacancy content, 0.2<x≤0.5, 0.4<y≤0.7, 0<x+y<1, 0.8<z≤1.2, and 0≤δ≤1.0.

The perovskite compound may have, for example, an AMO₃ phase, wherein vacancy and lithium (Li) are arranged in a part of A site. The perovskite compound may have an orthorhombic phase, a cubic phase, a monoclinic phase, a triclinic phase, each of which has an oxygen defect, or a crystalline phase of any combination of the foregoing. In addition, the lithium ion conductor may be improved by optimizing the lithium concentration in the A site, and the electronic conductor may be improved by introducing a metal (M) having improved lithium ionic conductivity and M having a low energy of generating an oxygen defect in the A site.

The perovskite compound may include, for example, a MO₆ orthorhombic phase, wherein the MO₆ orthorhombic phase has vertices occupied by 6 oxygen atoms and has a structure in which M in Formula 1 is positioned at the center of oxygen octahedra and corners are shared. In addition, the perovskite compound may have a structure in which La, Li, and a vacancy are randomly distributed according to a composition ratio in a space formed by the vertices of the orthorhombic phase. For example, in the perovskite compound, Li ions may be conducted via a vacant layer of La while electrons are conducted to a metal (M) ionic layer.

In the perovskite compound, La may be randomly distributed in each layer, and accordingly, shows a peak at an XRD diffraction angle (28) of around 23°, for example, 23°±2.5°.

For example, as a result of the XRD analysis, the perovskite compound shows a primary peak at a diffraction angle 2θ of 32.5°±2.5° and a sub-peak at a diffraction angle 2θ of 46.5°±2.5° and/or a diffraction angle 2θ of 57.5°±2.5°, each when analyzed using Cu K_{α} radiation. The primary peak refers to a peak having the largest intensity, and in this regard, the sub-peak has smaller intensity than that of the main peak.

For example, the perovskite compound may have a peak density ratio (I_{b}/Iₐ) of a peak (I (46.5°±2.5°): I_{b}) at a diffraction angle 2θ of 46.5°±2.5° to a peak (I (32.5°±2.5°): Iₐ) at a diffraction angle 2θ of 32.5°±2.5° to in an XRD pattern (I_{b}/Iₐ) of 0.1 or greater, for example, in a range of 0.1 to 0.9, and for example, in a range of 0.2 to 0.6. The perovskite compound may have a peak intensity ratio (I_{c}/Iₐ) of a peak (I (57.5°±2.5°): Ic) at a diffraction angle 2θ of 57.5°±2.5° to a peak (I (32.5°±2.5°): Iₐ) at a diffraction angle 2θ of 32.5°±2.5° in an XRD pattern of 0.1 or greater, for example, in a range of 0.1 to 0.9, and for example, in a range of 0.2 to 0.8, and for example, in a range of 0.2 to 0.4, when analyzed using Cu K_{α} radiation.

The perovskite compound may include, for example, at least one of Li_{0.34}La_{0.55}TiO_{3-δ}(0≤δ≤1.0), Li_{0.34}La_{0.55}MnO_{3-δ}(0≤δ≤1.0), Li_{0.34}La_{0.55}NiO_{3-δ}(0≤δ≤1.0), Li_{0.34}La_{0.55}CrO_{3-δ}(0≤δ≤1.0), Li_{0.34}La_{0.55}CoO_{3-δ}(0≤δ≤1.0), Li_{0.34}La_{0.55}IrO_{3-δ}(0≤δ≤1.0), Li_{0.34}La_{0.55}RuO_{3-δ}(0≤δ≤1.0), Li_{0.34}La_{0.55}TiO_{3-δ}(0≤δ≤1.0), Li_{0.34}La_{0.55}FeO_{3-δ}(0≤δ≤1.0), Li_{0.34}La_{0.55}PdO_{3-δ}(0≤δ≤1.0), Li_{0.34}La_{0.55}PbO_{3-δ}(0≤δ≤1.0), Li_{0.34}La_{0.55}RhO_{3-δ}(0≤δ≤1.0), Li_{0.34}La_{0.55}SnO_{3-δ}(0≤δ≤1.0), Li_{0.34}La_{0.55}VO_{3-δ}(0≤δ≤1.0), Li_{0.34}La_{0.55}ReO_{3-δ}(0≤δ≤1.0), Li_{0.34}La_{0.55}GeO_{3-δ}(0≤δ≤1.0), Li_{0.34}La_{0.55}WO_{3-δ}(0≤δ≤1.0), Li_{0.34}La_{0.55}ZrO_{3-δ}(0≤δ≤1.0), Li_{0.34}La_{0.55}MoO_{3-δ}(0≤δ≤1.0), Li_{0.34}La_{0.55}NbO_{3-δ}(0≤δ≤1.0), Li_{0.34}La_{0.55}TaO_{3-δ}(0≤δ≤1.0), Li_{0.34}La_{0.55}HfO_{3-δ}(0≤δ≤1.0), Li_{0.34}La_{0.55}BiO_{3-δ}(0≤δ≤1.0),

Li_{0.10}La_{0.63}TiO_{3-δ}(0≤δ≤1.0), Li_{0.10}La_{0.63}MnO_{3-δ}(0≤δ≤1.0), Li_{0.10}La_{0.63}NiO_{3-δ}(0≤δ≤1.0), Li_{0.10}La_{0.63}CrO_{3-δ}(0≤δ≤1.0), Li_{0.10}La_{0.63}CoO_{3-δ}(0≤δ≤1.0), Li_{0.10}La_{0.63}IrO_{3-δ}(0≤δ≤1.0), Li_{0.10}La_{0.63}RuO_{3-δ}(0≤δ≤1.0), Li_{0.10}La_{0.63}TiO_{3-δ}(0≤δ≤1.0), Li_{0.10}La_{0.63}FeO_{3-δ}(0≤δ≤1.0), Li_{0.10}La_{0.63}PdO_{3-δ}(0≤δ≤1.0), Li_{0.10}La_{0.63}PbO_{3-δ}(0≤δ≤1.0), Li_{0.10}La_{0.63}RhO_{3-δ}(0≤δ≤1.0), Li_{0.10}La_{0.63}SnO_{3-δ}(0≤δ≤1.0), Li_{0.10}La_{0.63}VO_{3-δ}(0≤δ≤1.0), Li_{0.10}La_{0.63}ReO_{3-δ}(0≤δ≤1.0), Li_{0.10}La_{0.63}GeO_{3-δ}(0≤δ≤1.0), Li_{0.10}La_{0.63}WO_{3-δ}(0≤δ≤1.0), Li_{0.10}La_{0.63}ZrO_{3-δ}(0≤δ1.0), Li_{0.10}La_{0.63}MoO_{3-δ}(0≤δ≤1.0), Li_{0.10}La_{0.63}NbO_{3-δ}(0≤δ≤1.0), Li_{0.10}La_{0.63}TaO_{3-δ}(0≤δ≤1.0), Li_{0.10}La_{0.63}HfO_{3-δ}(0≤δ≤1.0), Li_{0.10}La_{0.63}BiO_{3-δ}(0≤δ≤1.0),

Li_{0.20}La_{0.60}TiO_{3-δ}(0≤δ≤1.0), Li_{0.20}La_{0.60}MnO_{3-δ}(0≤δ≤1.0), Li_{0.20}La_{0.60}NiO_{3-δ}(0≤δ≤1.0), Li_{0.20}La_{0.60}CrO_{3-δ}(0≤δ≤1.0), Li_{0.20}La_{0.60}CoO_{3-δ}(0≤δ≤1.0), Li_{0.20}La_{0.60}IrO_{3-δ}(0≤δ≤1.0), Li_{0.20}La_{0.60}RuO_{3-δ}(0≤δ≤1.0), Li_{0.20}La_{0.60}TiO_{3-δ}(0≤δ≤1.0), Li_{0.20}La_{0.60}FeO_{3-δ}(0≤δ≤1.0), Li_{0.20}La_{0.60}PdO_{3-δ}(0≤δ≤1.0), Li_{0.20}La_{0.60}PbO_{3-δ}(0≤δ≤1.0), Li_{0.20}La_{0.60}RhO_{3-δ}(0≤δ≤1.0), Li_{0.20}La_{0.60}SnO_{3-δ}(0≤δ≤1.0), Li_{0.20}La_{0.60}VO_{3-δ}(0≤δ≤1.0), Li_{0.20}La_{0.60}ReO_{3-δ}(0≤δ≤1.0), Li_{0.20}La_{0.60}GeO_{3-δ}(0≤δ≤1.0), Li_{0.20}La_{0.60}WO_{3-δ}(0≤δ≤1.0), Li_{0.20}La_{0.60}ZrO_{3-δ}(0≤δ≤1.0), Li_{0.20}La_{0.60}MoO_{3-δ}(0≤δ≤1.0), Li_{0.20}La_{0.60}NbO_{3-δ}(0≤δ≤1.0), Li_{0.20}La_{0.60}TaO_{3-δ}(0≤δ≤1.0), Li_{0.20}La_{0.60}HfO_{3-δ}(0≤δ≤1.0), Li_{0.20}La_{0.60}BiO_{3-δ}(0≤δ≤1.0),

Li_{0.30}La_{0.57}TiO_{3-δ}(0≤δ≤1.0), Li_{0.30}La_{0.57}MnO_{3δ}(0≤δ≤1.0), Li_{0.30}La_{0.57}NiO_{3-δ}(0≤δ≤1.0), Li_{0.30}La_{0.57}CrO_{3-δ}(0≤δ≤1.0), Li_{0.30}La_{0.57}CoO_{3-δ}(0≤δ≤1.0), Li_{0.30}La_{0.57}O_{3-δ}(0≤δ≤1.0), Li_{0.30}La_{0.57}RuO_{3-δ}(0≤δ≤1.0), Li_{0.30}La_{0.57}TiO_{3-δ}(0≤δ≤1.0), Li_{0.30}La_{0.57}FeO_{3-δ}(0≤δ≤1.0), Li_{0.30}La_{0.57}PdO_{3-δ}(0≤δ≤1.0), Li_{0.30}La_{0.57}PbO_{3-δ}(0≤δ≤1.0), Li_{0.30}La_{0.57}RhO_{3-δ}(0≤δ≤1.0), Li_{0.30}La_{0.57}SnO_{3-δ}(0≤δ≤1.0), Li_{0.30}La_{0.57}VO_{3-δ}(0≤δ≤1.0), Li_{0.30}La_{0.57}ReO_{3-δ}(0≤δ≤1.0), Li_{0.30}La_{0.57}GeO_{3-δ}(0≤δ≤1.0), Li_{0.30}La_{0.57}WO_{3-δ}(0≤δ≤1.0), Li_{0.30}La_{0.57}ZrO_{3-δ}(0≤δ≤1.0), Li_{0.30}La_{0.57}MoO_{3-δ}(0≤δ≤1.0), Li_{0.30}La_{0.57}NbO_{3-δ}(0≤δ≤1.0), Li_{0.30}La_{0.57}TaO_{3-δ}(0≤δ≤1.0), Li_{0.30}La_{0.57}HfO_{3-δ}(0≤δ≤1.0), Li_{0.30}La_{0.57}BiO_{3-δ}(0≤δ≤1.0),

Li_{0.40}La_{0.53}TiO_{3-δ}(0≤δ≤1.0), Li_{0.40}La_{0.53}MnO_{3-δ}(0≤δ≤1.0), Li_{0.40}La_{0.53}NiO_{3-δ}(0≤δ≤1.0), Li_{0.40}La_{0.53}CrO_{3-δ}(0≤δ≤1.0), Li_{0.40}La_{0.53}CoO_{3-δ}(0≤δ≤1.0), Li_{0.40}La_{0.53}IrO_{3-δ}(0≤δ≤1.0), Li_{0.40}La_{0.53}RuO_{3-δ}(0≤δ≤1.0), Li_{0.40}La_{0.53}TiO_{3-δ}(0≤δ≤1.0), Li_{0.40}La_{0.53}FeO_{3-δ}(0≤δ≤1.0), Li_{0.40}La_{0.53}PdO_{3-δ}(0≤δ≤1.0), Li_{0.40}La_{0.53}PbO_{3-δ}(0≤δ≤1.0), Li_{0.40}La_{0.53}RhO_{3-δ}(0≤δ≤1.0), Li_{0.40}La_{0.53}SnO_{3-δ}(0≤δ≤1.0), Li_{0.40}La_{0.53}VO_{3-δ}(0≤δ≤1.0), Li_{0.40}La_{0.53}ReO_{3-δ}(0≤δ≤1.0), Li_{0.40}La_{0.53}GeO_{3-δ}(0≤δ≤1.0), Li_{0.40}La_{0.53}WO_{3-δ}(0≤δ≤1.0), Li_{0.40}La_{0.53}ZrO_{3-δ}(0≤δ≤1.0), Li_{0.40}La_{0.53}MoO_{3-δ}(0≤δ≤1.0), Li_{0.40}La_{0.53}NbO_{3-δ}(0≤δ≤1.0), Li_{0.40}La_{0.53}TaO_{3-δ}(0≤δ≤1.0), Li_{0.40}La_{0.53}HfO_{3-δ}(0≤δ≤1.0), Li_{0.40}La_{0.53}BiO_{3-δ}(0≤δ≤1.0),

Li_{0.45}La_{0.52}TiO_{3-δ}(0≤δ≤1.0), Li_{0.45}La_{0.52}MnO_{3-δ}(0≤δ≤1.0), Li_{0.45}La_{0.52}NiO_{3-δ}(0≤δ≤1.0), Li_{0.45}La_{0.52}CrO_{3-δ}(0≤δ≤1.0), Li_{0.45}La_{0.52}CoO_{3-δ}(0≤δ≤1.0), Li_{0.45}La_{0.52}IrO_{3-δ}(0≤δ≤1.0), Li_{0.45}La_{0.52}RuO_{3-δ}(0≤δ≤1.0), Li_{0.45}La_{0.52}TiO_{3-δ}(0≤δ≤1.0), Li_{0.45}La_{0.52}FeO_{3-δ}(0≤δ≤1.0), Li_{0.45}La_{0.52}PdO_{3-δ}(0≤δ≤1.0), Li_{0.45}La_{0.52}PbO_{3-δ}(0≤δ≤1.0), Li_{0.45}La_{0.52}RhO_{3-δ}(0≤δ≤1.0), Li_{0.45}La_{0.52}SnO_{3-δ}(0≤δ≤1.0), Li_{0.45}La_{0.52}VO_{3-δ}(0≤δ≤1.0), Li_{0.45}La_{0.52}ReO_{3-δ}(0≤δ≤1.0), Li_{0.45}La_{0.52}GeO_{3-δ}(0≤δ≤1.0), Li_{0.45}La_{0.52}WO_{3-δ}(0≤δ≤1.0), Li_{0.45}La_{0.52}ZrO_{3-δ}(0≤δ≤1.0), Li_{0.45}La_{0.52}MoO_{3-δ}(0≤δ≤1.0), Li_{0.45}La_{0.52}NbO_{3-δ}(0≤δ≤1.0), Li_{0.45}La_{0.52}TaO_{3-δ}(0≤δ≤1.0), Li_{0.45}La_{0.52}HfO_{3-δ}(0≤δ≤1.0), Li_{0.45}La_{0.52}BiO_{3-δ}(0≤δ≤1.0),

Li_{0.34}Ce_{0.55}TiO_{3-δ}(0≤δ≤1.0), Li_{0.34}Ce_{0.55}MnO_{3-δ}(0≤δ≤1.0), Li_{0.34}Ce_{0.55}NiO_{3-δ}(0≤δ≤1.0), Li_{0.34}Ce_{0.55}CrO_{3-δ}(0≤δ≤1.0), Li_{0.34}Ce_{0.55}CO_{3-δ}(0≤δ≤1.0), Li_{0.34}Ce_{0.55}IrO_{3-δ}(0≤δ≤1.0), Li_{0.34}Ce_{0.55}RuO_{3-δ}(0≤δ≤1.0), Li_{0.34}Ce_{0.55}TiO_{3-δ}(0≤δ≤1.0), Li_{0.34}Ce_{0.55}FeO_{3-δ}(0≤δ≤1.0), Li_{0.34}Ce_{0.55}PdO_{3-δ}(0≤δ≤1.0), Li_{0.34}Ce_{0.55}PbO_{3-δ}(0≤δ≤1.0), Li_{0.34}Ce_{0.55}RhO_{3-δ}(0≤δ≤1.0), Li_{0.34}Ce_{0.55}SnO_{3-δ}(0≤δ≤1.0), Li_{0.34}Ce_{0.55}VO_{3-δ}(0≤δ≤1.0), Li_{0.34}Ce_{0.55}ReO_{3-δ}(0≤δ≤1.0), Li_{0.34}Ce_{0.55}GeO_{3-δ}(0≤δ≤1.0), Li_{0.34}Ce_{0.55}WO_{3-δ}(0≤δ≤1.0), Li_{0.34}Ce_{0.55}ZrO_{3-δ}(0≤δ≤1.0), Li_{0.34}Ce_{0.55}MoO_{3-δ}(0≤δ≤1.0), Li_{0.34}Ce_{0.55}NbO_{3-δ}(0≤δ≤1.0), Li_{0.34}Ce_{0.55}TaO_{3-δ}(0≤δ≤1.0), Li_{0.34}Ce_{0.55}HfO_{3-δ}(0≤δ≤1.0), Li_{0.34}Ce_{0.55}BiO_{3-δ}(0≤δ≤1.0),

Li_{0.10}Ce_{0.63}TiO_{3-δ}(0≤δ≤1.0), Li_{0.10}Ce_{0.63}MnO_{3-δ}(0≤δ≤1.0), Li_{0.10}Ce_{0.63}NO_{3-δ}(0≤δ≤1.0), Li_{0.10}Ce_{0.63}CrO_{3-δ}(0≤δ≤1.0), Li_{0.10}Ce_{0.63}CoO_{3-δ}(0≤δ≤1.0), Li_{0.10}Ce_{0.63}IrO_{3-δ}(0≤δ≤1.0)₃, Li_{0.10}Ce_{0.63}RuO_{3-δ}(0≤δ≤1.0), Li_{0.10}Ce_{0.63}TiO_{3-δ}(0≤δ≤1.0), Li_{0.10}Ce_{0.63}FeO_{3-δ}(0≤δ≤1.0), Li_{0.10}Ce_{0.63}PdO_{3-δ}(0≤δ≤1.0), Li_{0.10}Ce_{0.63}PbO_{3-δ}(0≤δ≤1.0), Li_{0.10}Ce_{0.63}RhO_{3-δ}(0≤δ≤1.0), Li_{0.10}Ce_{0.63}SnO_{3-δ}(0≤δ≤1.0), Li_{0.10}Ce_{0.63}VO_{3-δ}(0≤δ≤1.0), Li_{0.10}Ce_{0.63}ReO_{3-δ}(0≤δ≤1.0), Li_{0.10}Ce_{0.63}GeO_{3-δ}(0≤δ≤1.0), Li_{0.10}Ce_{0.63}WO_{3-δ}(0≤δ≤1.0), Li_{0.10}Ce_{0.63}ZrO_{3-δ}(0≤δ≤1.0), Li_{0.10}Ce_{0.63}MoO_{3-δ}(0≤δ≤1.0), Li_{0.10}Ce_{0.63}NbO_{3-δ}(0≤δ≤1.0), Li_{0.10}Ce_{0.63}TaO_{3-δ}(0≤δ≤1.0), Li_{0.10}Ce_{0.63}HfO_{3-δ}(0≤δ≤1.0), Li_{0.10}Ce_{0.63}BiO_{3-δ}(0≤δ≤1.0),

Li_{0.20}Ce_{0.60}TiO_{3-δ}(0≤δ≤1.0), Li_{0.20}Ce_{0.60}MnO_{3-δ}(0≤δ≤1.0), Li_{0.20}Ce_{0.60}NiO_{3-δ}(0≤δ≤1.0), Li_{0.20}Ce_{0.60}CrO_{3-δ}(0≤δ≤1.0), Li_{0.20}Ce_{0.6}CoO_{3-δ}(0≤δ≤1.0), Li_{0.20}Ce_{0.60}IrO_{3-δ}(0≤δ≤1.0), Li_{0.20}Ce_{0.60}RuO_{3-δ}(0≤δ≤1.0), Li_{0.20}Ce_{0.60}TiO_{3-δ}(0≤δ≤1.0), Li_{0.20}Ce_{0.60}FeO_{3-δ}(0≤δ≤1.0), Li_{0.20}Ce_{0.60}PdO_{3-δ}(0≤δ≤1.0), Li_{0.20}Ce_{0.60}PbO_{3-δ}(0≤δ≤1.0), Li_{0.20}Ce_{0.60}RhO_{3-δ}(0≤δ≤1.0), Li_{0.20}Ce_{0.60}SnO_{3-δ}(0≤δ≤1.0), Li_{0.20}Ce_{0.60}VO_{3-δ}(0≤δ≤1.0), Li_{0.20}Ce_{0.60}ReO_{3-δ}(0≤δ≤1.0), Li_{0.20}Ce_{0.60}GeO_{3-δ}(0≤δ≤1.0), Li_{0.20}Ce_{0.60}WO_{3-δ}(0≤δ≤1.0), Li_{0.20}Ce_{0.60}ZrO_{3-δ}(0≤δ≤1.0), Li_{0.20}Ce_{0.60}MoO_{3-δ}(0≤δ≤1.0), Li_{0.20}Ce_{0.60}NbO_{3-δ}(0≤δ≤1.0), Li_{0.20}Ce_{0.60}TaO_{3-δ}(0≤δ≤1.0), Li_{0.20}Ce_{0.60}HfO_{3-δ}(0≤δ≤1.0), Li_{0.20}Ce_{0.60}BiO_{3-δ}(0≤δ≤1.0),

Li_{0.30}Ce_{0.57}TiO_{3-δ}(0≤δ≤1.0), Li_{0.30}Ce_{0.57}MnO_{3-δ}(0≤δ≤1.0), Li_{0.30}Ce_{0.57}NiO_{3-δ}(0≤δ≤1.0), Li_{0.30}Ce_{0.57}CrO_{3-δ}(0≤δ≤1.0), Li_{0.30}Ce_{0.57}CO_{3-δ}(0≤δ≤1.0), Li_{0.30}Ce_{0.57}IrO_{3-δ}(0≤δ≤1.0), Li_{0.30}Ce_{0.57}RuO_{3-δ}(0≤δ≤1.0), Li_{0.30}Ce_{0.57}TiO_{3-δ}(0≤δ≤1.0), Li_{0.30}Ce_{0.57}FeO_{3-δ}(0≤δ≤1.0), Li_{0.30}Ce_{0.57}PdO_{3-δ}(0≤δ≤1.0), Li_{0.30}Ce_{0.57}PbO_{3-δ}(0≤δ≤1.0), Li_{0.30}Ce_{0.57}RhO_{3-δ}(0≤δ≤1.0), Li_{0.30}Ce_{0.57}SnO_{3-δ}(0≤δ≤1.0), Li_{0.30}Ce_{0.57}VO_{3-δ}(0≤δ≤1.0), Li_{0.30}Ce_{0.57}ReO_{3-δ}(0≤δ≤1.0), Li_{0.30}Ce_{0.57}GeO_{3-δ}(0≤δ≤1.0), Li_{0.30}Ce_{0.57}WO_{3-δ}(0≤δ≤1.0), Li_{0.30}Ce_{0.57}ZrO_{3-δ}(0≤δ≤1.0), Li_{0.30}Ce_{0.57}MO_{3-δ}(0≤δ≤1.0), Li_{0.30}Ce_{0.57}NbO_{3-δ}(0≤δ≤1.0), Li_{0.30}Ce_{0.57}TaO_{3-δ}(0≤δ≤1.0), Li_{0.30}Ce_{0.57}HfO_{3-δ}(0≤δ≤1.0), Li_{0.30}Ce_{0.57}BiO_{3-δ}(0≤δ≤1.0),

Li_{0.40}Ce_{0.53}TiO_{3-δ}(0≤δ≤1.0), Li_{0.40}Ce_{0.53}MnO_{3-δ}(0≤δ≤1.0), Li_{0.40}Ge_{0.53}NiO_{3-δ}(0≤δ≤1.0), Li_{0.40}Ce_{0.53}CrO_{3-δ}(0≤δ≤1.0), Li_{0.40}Ce_{0.53}CoO_{3-δ}(0≤δ≤1.0), Li_{0.40}Ce_{0.53}IrO_{3-δ}(0≤δ≤1.0), Li_{0.40}Ce_{0.53}RuO_{3-δ}(0≤δ≤1.0), Li_{0.40}Ce_{0.53}TiO_{3-δ}(0≤δ≤1.0), Li_{0.40}Ce_{0.53}FeO_{3-δ}(0≤δ≤1.0), Li_{0.40}Ce_{0.53}PdO_{3-δ}(0≤δ≤1.0), Li_{0.40}Ce_{0.53}PbO_{3-δ}(0≤δ≤1.0), Li_{0.40}Ce_{0.53}RhO_{3-δ}(0≤δ≤1.0), Li_{0.40}Ce_{0.53}SnO_{3-δ}(0≤δ≤1.0), Li_{0.40}Ce_{0.53}VO_{3-δ}(0≤δ≤1.0), Li_{0.40}Ce_{0.53}ReO_{3-δ}(0≤δ≤1.0), Li_{0.40}Ce_{0.53}GeO_{3-δ}(0≤δ≤1.0), Li_{0.40}Ce_{0.53}WO_{3-δ}(0≤δ≤1.0), Li_{0.40}Ce_{0.53}ZrO_{3-δ}(0≤δ≤1.0), Li_{0.40}Ce_{0.53}MoO_{3-δ}(0≤δ≤1.0), Li_{0.40}Ce_{0.53}NbO_{3-δ}(0≤δ≤1.0), Li_{0.40}Ce_{0.53}TaO_{3-δ}(0≤δ≤1.0), Li_{0.40}Ce_{0.53}HfO_{3-δ}(0≤δ≤1.0), Li_{0.40}Ce_{0.53}BiO_{3-δ}(0≤δ≤1.0),

Li_{0.45}Ce_{0.52}TiO_{3-δ}(0≤δ≤1.0), Li_{0.45}Ce_{0.52}MnO_{3-δ}(0≤δ≤1.0), Li_{0.45}Ce_{0.52}NiO_{3-δ}(0≤δ≤1.0), Li_{0.45}Ce_{0.52}CrO_{3-δ}(0≤δ≤1.0), Li_{0.45}Ce_{0.52}CoO_{3-δ}(0≤δ≤1.0), Li_{0.45}Ce_{0.52}IrO_{3-δ}(0≤δ≤1.0), Li_{0.45}Ce_{0.52}RuO_{3-δ}(0≤δ≤1.0), Li_{0.45}Ce_{0.52}TiO_{3-δ}(0≤δ≤1.0), Li_{0.45}Ce_{0.52}FeO_{3-δ}(0≤δ≤1.0), Li_{0.45}Ce_{0.52}PdO_{3-δ}(0≤δ≤1.0), Li_{0.45}Ce_{0.52}PbO_{3-δ}(0≤δ≤1.0), Li_{0.45}Ce_{0.52}RhO_{3-δ}(0≤δ≤1.0), Li_{0.45}Ce_{0.52}SnO_{3-δ}(0≤δ≤1.0), Li_{0.45}Ce_{0.52}VO_{3-δ}(0≤δ≤1.0), Li_{0.45}Ce_{0.52}ReO_{3-δ}(0≤δ≤1.0), Li_{0.45}Ce_{0.52}GeO_{3-δ}(0≤δ≤1.0), Li_{0.45}Ce_{0.52}WO_{3-δ}(0≤δ≤1.0), Li_{0.45}Ce_{0.52}ZrO_{3-δ}(0≤δ≤1.0), Li_{0.45}Ce_{0.52}MoO_{3-δ}(0≤δ≤1.0), Li_{0.45}Ce_{0.52}NbO_{3-δ}(0≤δ≤1.0), Li_{0.45}Ce_{0.52}TaO_{3-δ}(0≤δ≤1.0), Li_{0.45}Ce_{0.52}HfO_{3-δ}(0≤δ≤1.0), Li_{0.45}Ce_{0.52}BiO_{3-δ}(0≤δ≤1.0),

Li_{0.34}Pr_{0.55}TiO_{3-δ}(0≤δ≤1.0), Li_{0.34}Pr_{0.55}MnO_{3-δ}(0≤δ≤1.0), Li_{0.34}Pr_{0.55}NiO_{3-δ}(0≤δ≤1.0), Li_{0.34}Pr_{0.55}CrO_{3-δ}(0≤δ≤1.0), Li_{0.34}Pr_{0.55}CoO_{3-δ}(0≤δ≤1.0), Li_{0.34}Pr_{0.55}IrO_{3-δ}(0≤δ≤1.0), Li_{0.34}Pr_{0.55}RuO_{3-δ}(0≤δ≤1.0), Li_{0.34}Pr_{0.55}TiO_{3-δ}(0≤δ≤1.0), Li_{0.34}Pr_{0.55}FeO_{3-δ}(0≤δ≤1.0), Li_{0.34}Pr_{0.55}PdO_{3-δ}(0≤δ≤1.0), Li_{0.34}Pr_{0.55}PbO_{3-δ}(0≤δ≤1.0), Li_{0.34}Pr_{0.55}RhO_{3-δ}(0≤δ≤1.0), Li_{0.34}Pr_{0.55}SnO_{3-δ}(0≤δ≤1.0), Li_{0.34}Pr_{0.55}VO_{3-δ}(0≤δ≤1.0), Li_{0.34}Pr_{0.55}ReO_{3-δ}(0≤δ≤1.0), Li_{0.34}Pr_{0.55}GeO_{3-δ}(0≤δ≤1.0), Li_{0.34}Pr_{0.55}WO_{3-δ}(0≤δ≤1.0), Li_{0.34}Pr_{0.55}ZrO_{3-δ}(0≤δ≤1.0), Li_{0.34}Pr_{0.55}MO_{3-δ}(0≤δ≤1.0), Li_{0.34}Pr_{0.55}NbO_{3-δ}(0≤δ≤1.0), Li_{0.34}Pr_{0.55}TaO_{3-δ}(0≤δ≤1.0), Li_{0.34}Pr_{0.55}HfO_{3-δ}(0≤δ≤1.0), Li_{0.34}Pr_{0.55}BiO_{3-δ}(0≤δ≤1.0),

Li_{0.10}Pr_{0.63}TiO_{3-δ}(0≤δ≤1.0), Li_{0.10}Pr_{0.63}MnO_{3-δ}(0≤δ≤1.0), Li_{0.10}Pr_{0.63}NiO_{3-δ}(0≤δ≤1.0), Li_{0.10}Pr_{0.63}CrO_{3-δ}(0≤δ≤1.0), Li_{0.10}Pr_{0.63}CoO_{3-δ}(0≤δ≤1.0), Li_{0.10}Pr_{0.63}IrO_{3-δ}(0≤δ≤1.0), Li_{0.10}Pr_{0.63}RuO_{3-δ}(0≤δ≤1.0), Li_{0.10}Pr_{0.63}TiO_{3-δ}(0≤δ≤1.0), Li_{0.10}Pr_{0.63}FeO_{3-δ}(0≤δ≤1.0), Li_{0.10}Pr_{0.63}PdO_{3-δ}(0≤δ≤1.0), Li_{0.10}Pr_{0.63}PbO_{3-δ}(0≤δ≤1.0), Li_{0.10}Pr_{0.63}RhO_{3-δ}(0≤δ≤1.0), Li_{0.10}Pr_{0.63}SnO_{3-δ}(0≤δ≤1.0), Li_{0.10}Pr_{0.63}VO_{3-δ}(0≤δ≤1.0), Li_{0.10}Pr_{0.63}ReO_{3-δ}(0≤δ≤1.0), Li_{0.10}Pr_{0.63}GeO_{3-δ}(0≤δ≤1.0), Li_{0.10}Pr_{0.63}WO_{3-δ}(0≤δ≤1.0), Li_{0.10}Pr_{0.63}ZrO_{3-δ}(0≤δ≤1.0), Li_{0.10}Pr_{0.63}MoO_{3-δ}(0≤δ≤1.0), Li_{0.10}Pr_{0.63}NbO_{3-δ}(0≤δ≤1.0), Li_{0.10}Pr_{0.63}TaO_{3-δ}(0≤δ≤1.0), Li_{0.10}Pr_{0.63}HfO_{3-δ}(0≤δ≤1.0), Li_{0.10}Pr_{0.63}BiO_{3-δ}(0≤δ≤1.0),

Li_{0.20}Pr_{0.60}TiO_{3-δ}(0≤δ≤1.0), Li_{0.20}Pr_{0.60}MnO_{3-δ}(0≤δ≤1.0), Li_{0.20}Pr_{0.60}NiO_{3-δ}(0≤δ≤1.0), Li_{0.20}Pr_{0.60}CrO_{3-δ}(0≤δ≤1.0), Li_{0.20}Pr_{0.60}CoO_{3-δ}(0≤δ≤1.0), Li_{0.20}Pr_{0.60}IrO_{3-δ}(0≤δ≤1.0), Li_{0.20}Pr_{0.60}RuO_{3-δ}(0≤δ≤1.0), Li_{0.20}Pr_{0.60}TiO_{3-δ}(0≤δ≤1.0), Li_{0.20}Pr_{0.60}FeO_{3-δ}(0≤δ≤1.0), Li_{0.20}Pr_{0.60}PdO_{3-δ}(0≤δ≤1.0), Li_{0.20}Pr_{0.60}PbO_{3-δ}(0≤δ≤1.0), Li_{0.20}Pr_{0.60}RhO_{3-δ}(0≤δ≤1.0), Li_{0.20}Pr_{0.60}SnO_{3-δ}(0≤δ≤1.0), Li_{0.20}Pr_{0.60}VO_{3-δ}(0≤δ≤1.0), Li_{0.20}Pr_{0.60}ReO_{3-δ}(0≤δ≤1.0), Li_{0.20}Pr_{0.60}GeO_{3-δ}(0≤δ≤1.0), Li_{0.20}Pr_{0.60}WO_{3-δ}(0≤δ≤1.0), Li_{0.20}Pr_{0.60}ZrO_{3-δ}(0≤δ≤1.0), Li_{0.20}Pr_{0.60}MoO_{3-δ}(0≤δ≤1.0), Li_{0.20}Pr_{0.60}NbO_{3-δ}(0≤δ≤1.0), Li_{0.20}Pr_{0.60}TaO_{3-δ}(0≤δ≤1.0), Li_{0.20}Pr_{0.60}HfO_{3-δ}(0≤δ≤1.0), Li_{0.20}Pr_{0.60}BiO_{3-δ}(0≤δ≤1.0),

Li_{0.30}Pr_{0.57}TiO_{3-δ}(0≤δ≤1.0), Li_{0.30}Pr_{0.57}MnO_{3-δ}(0≤δ≤1.0), Li_{0.30}Pr_{0.57}NiO_{3-δ}(0≤δ≤1.0), Li_{0.30}Pr_{0.57}CrO_{3-δ}(0≤δ≤1.0), Li_{0.30}Pr_{0.57}CoO_{3-δ}(0≤δ≤1.0), Li_{0.30}Pr_{0.57}IrO_{3-δ}(0≤δ≤1.0), Li_{0.30}Pr_{0.57}RuO_{3-δ}(0≤δ≤1.0), Li_{0.30}Pr_{0.57}TiO_{3-δ}(0≤δ≤1.0), Li_{0.30}Pr_{0.57}FeO_{3-δ}(0≤δ≤1.0), Li_{0.30}Pr_{0.57}PdO_{3-δ}(0≤δ≤1.0), Li_{0.30}Pr_{0.57}PbO_{3-δ}(0≤δ≤1.0), Li_{0.30}Pr_{0.57}RhO_{3-δ}(0≤δ≤1.0), Li_{0.30}Pr_{0.57}SnO_{3-δ}(0≤δ≤1.0), Li_{0.30}Pr_{0.57}VO_{3-δ}(0≤δ≤1.0), Li_{0.30}Pr_{0.57}ReO_{3-δ}(0≤δ≤1.0), Li_{0.30}Pr_{0.57}GeO_{3-δ}(0≤δ≤1.0), Li_{0.30}Pr_{0.57}WO_{3-δ}(0≤δ≤1.0), Li_{0.30}Pr_{0.57}ZrO_{3-δ}(0≤δ≤1.0), Li_{0.30}Pr_{0.57}MoO_{3-δ}(0≤δ≤1.0), Li_{0.30}Pr_{0.57}NbO_{3-δ}(0≤δ≤1.0), Li_{0.30}Pr_{0.57}TaO_{3-δ}(0≤δ≤1.0), Li_{0.30}Pr_{0.57}HfO_{3-δ}(0≤δ≤1.0), Li_{0.30}Pr_{0.57}BiO_{3-δ}(0≤δ≤1.0),

Li_{0.40}Pr_{0.53}TiO_{3-δ}(0≤δ≤1.0), Li_{0.40}Pr_{0.53}MnO_{3-δ}(0≤δ≤1.0), Li_{0.40}Pr_{0.53}NiO_{3-δ}(0≤δ≤1.0), Li_{0.40}Pr_{0.53}CrO_{3-δ}(0≤δ≤1.0), Li_{0.40}Pr_{0.53}CO_{3-δ}(0≤δ≤1.0), Li_{0.40}Pr_{0.53}IrO_{3-δ}(0≤δ≤1.0), Li_{0.40}Pr_{0.53}RuO_{3-δ}(0≤δ≤1.0), Li_{0.40}Pr_{0.53}TiO_{3-δ}(0≤δ≤1.0), Li_{0.40}Pr_{0.53}FeO_{3-δ}(0≤δ≤1.0), Li_{0.40}Pr_{0.53}PdO_{3-δ}(0≤δ≤1.0), Li_{0.40}Pr_{0.53}PbO_{3-δ}(0≤δ≤1.0), Li_{0.40}Pr_{0.53}RhO_{3-δ}(0≤δ≤1.0), Li_{0.40}Pr_{0.53}SnO_{3-δ}(0≤δ≤1.0), Li_{0.40}Pr_{0.53}VO_{3-δ}(0≤δ≤1.0), Li_{0.40}Pr_{0.53}ReO_{3-δ}(0≤δ≤1.0), Li_{0.40}Pr_{0.53}GeO_{3-δ}(0≤δ≤1.0), Li_{0.40}Pr_{0.53}WO_{3-δ}(0≤δ≤1.0), Li_{0.40}Pr_{0.53}ZrO_{3-δ}(0≤δ≤1.0), Li_{0.40}Pr_{0.53}MoO_{3-δ}(0≤δ≤1.0), Li_{0.40}Pr_{0.53}NbO_{3-δ}(0≤δ≤1.0), Li_{0.40}Pr_{0.53}TaO_{3-δ}(0≤δ≤1.0), Li_{0.40}Pr_{0.53}HfO_{3-δ}(0≤δ≤1.0), Li_{0.40}Pr_{0.53}BiO_{3-δ}(0≤δ≤1.0),

Li_{0.45}Pr_{0.52}TiO_{3-δ}(0≤δ≤1.0), Li_{0.45}Pr_{0.52}MnO_{3-δ}(0≤δ≤1.0), Li_{0.45}Pr_{0.52}NiO_{3-δ}(0≤δ≤1.0), Li_{0.45}Pr_{0.52}CrO_{3-δ}(0≤δ≤1.0), Li_{0.45}Pr_{0.52}CO_{3-δ}(0≤δ≤1.0), Li_{0.45}Pr_{0.52}IrO_{3-δ}(0≤δ≤1.0), Li_{0.45}Pr_{0.52}RuO_{3-δ}(0≤δ≤1.0), Li_{0.45}Pr_{0.52}TiO_{3-δ}(0≤δ≤1.0), Li_{0.45}Pr_{0.52}FeO_{3-δ}(0≤δ≤1.0), Li_{0.45}Pr_{0.52}PdO_{3-δ}(0≤δ≤1.0), Li_{0.45}Pr_{0.52}PbO_{3-δ}(0≤δ≤1.0), Li_{0.45}Pr_{0.52}RhO_{3-δ}(0≤δ≤1.0), Li_{0.45}Pr_{0.52}SnO_{3-δ}(0≤δ≤1.0), Li_{0.45}Pr_{0.52}VO_{3-δ}(0≤δ≤1.0), Li_{0.45}Pr_{0.52}ReO_{3-δ}(0≤δ≤1.0), Li_{0.45}Pr_{0.52}GeO_{3-δ}(0≤δ≤1.0), Li_{0.45}Pr_{0.52}WO_{3-δ}(0≤δ≤1.0), Li_{0.45}Pr_{0.52}ZrO_{3-δ}(0≤δ≤1.0), Li_{0.45}Pr_{0.52}MoO_{3-δ}(0≤δ≤1.0), Li_{0.45}Pr_{0.52}NbO_{3-δ}(0≤δ≤1.0), Li_{0.45}Pr_{0.52}TaO_{3-δ}(0≤δ≤1.0), Li_{0.45}Pr_{0.52}HfO_{3-δ}(0≤δ≤1.0), Li_{0.45}Pr_{0.52}BiO_{3-δ}(0≤δ≤1.0),

Li_{0.10}Ca_{0.80}TiO_{3-δ}(0≤δ≤1.0), Li_{0.10}Ca_{0.80}MnO_{3-δ}(0≤δ≤1.0), Li_{0.10}Ca_{0.80}NiO_{3-δ}(0≤δ≤1.0), Li_{0.10}Ca_{0.80}CrO_{3-δ}(0≤δ≤1.0), Li_{0.10}Ca_{0.80}CoO_{3-δ}(0≤δ1.0), Li_{0.10}Ca_{0.80}IrO_{3-δ}(0≤δ≤1.0), Li_{0.10}Ca_{0.80}RuO_{3-δ}(0≤δ≤1.0), Li_{0.10}Ca_{0.80}TiO_{3-δ}(0≤δ≤1.0), Li_{0.10}Ca_{0.80}FeO_{3-δ}(0≤δ≤1.0), Li_{0.10}Ca_{0.80}PdO_{3-δ}(0≤δ≤1.0), Li_{0.10}Ca_{0.80}PbO_{3-δ}(0≤δ≤1.0)), Li_{0.10}Ca_{0.80}RhO_{3-δ}(0≤δ≤1.0), Li_{0.10}Ca_{0.80}SnO_{3-δ}(0≤δ≤1.0), Li_{0.10}Ca_{0.80}VO_{3-δ}(0≤δ≤1.0), Li_{0.10}Ca_{0.80}ReO_{3-δ}(0≤δ≤1.0), Li_{0.10}Ca_{0.80}GeO_{3-δ}(0≤δ≤1.0), Li_{0.10}Ca_{0.80}WO_{3-δ}(0≤δ≤1.0), Li_{0.10}Ca_{0.80}ZrO_{3-δ}(0≤δ≤1.0), Li_{0.10}Ca_{0.80}MoO_{3-δ}(0≤δ≤1.0), Li_{0.10}Ca_{0.80}NbO_{3-δ}(0≤δ≤1.0), Li_{0.10}Ca_{0.80}TaO_{3-δ}(0≤δ≤1.0), Li_{0.10}Ca_{0.80}HfO_{3-δ}(0≤δ≤1.0), Li_{0.10}Ca_{0.80}BiO_{3-δ}(0≤δ≤1.0),

Li_{0.20}Ca_{0.60}TiO_{3-δ}(0≤δ≤1.0), Li_{0.20}Ca_{0.60}MnO_{3-δ}(0≤δ≤1.0), Li_{0.20}Ca_{0.60}NiO_{3-δ}(0≤δ≤1.0), Li_{0.20}Ca_{0.60}CrO_{3-δ}(0≤δ≤1.0), Li_{0.20}Ca_{0.60}CoO_{3-δ}(0≤δ≤1.0), Li_{0.20}Ca_{0.60}IrO_{3-δ}(0≤δ≤1.0), Li_{0.20}Ca_{0.60}RuO_{3-δ}(0≤δ≤1.0), Li_{0.20}Ca_{0.60}TiO_{3-δ}(0≤δ≤1.0), Li_{0.20}Ca_{0.60}FeO_{3-δ}(0≤δ≤1.0), Li_{0.20}Ca_{0.60}PdO_{3-δ}(0≤δ≤1.0), Li_{0.20}Ca_{0.60}PbO_{3-δ}(0≤δ≤1.0), Li_{0.20}Ca_{0.60}RhO_{3-δ}(0≤δ≤1.0), Li_{0.20}Ca_{0.60}SnO_{3-δ}(0≤δ≤1.0), Li_{0.20}Ca_{0.60}VO_{3-δ}(0≤δ≤1.0), Li_{0.20}Ca_{0.60}ReO_{3-δ}(0≤δ≤1.0), Li_{0.20}Ca_{0.60}GeO_{3-δ}(0≤δ≤1.0), Li_{0.20}Ca_{0.60}WO_{3-δ}(0≤δ≤1.0), Li_{0.20}Ca_{0.60}ZrO_{3-δ}(0≤δ≤1.0), Li_{0.20}Ca_{0.60}MoO_{3-δ}(0≤δ≤1.0), Li_{0.20}Ca_{0.60}NbO_{3-δ}(0≤δ≤1.0), Li_{0.20}Ca_{0.60}TaO_{3-δ}(0≤δ≤1.0), Li_{0.20}Ca_{0.60}HfO_{3-δ}(0≤δ≤1.0), Li_{0.20}Ca_{0.60}BiO_{3-δ}(0≤δ≤1.0),

Li_{0.25}Ca_{0.50}TiO_{3-δ}(0≤δ≤1.0), Li_{0.25}Ca_{0.50}MnO_{3-δ}(0≤δ≤1.0), Li_{0.25}Ca_{0.50}NiO_{3-δ}(0≤δ≤1.0), Li_{0.25}Ca_{0.50}CrO_{3-δ}(0≤δ≤1.0), Li_{0.25}Ca_{0.50}CoO_{3-δ}(0≤δ≤1.0), Li_{0.25}Ca_{0.50}IrO_{3-δ}(0≤δ≤1.0), Li_{0.25}Ca_{0.50}RuO_{3-δ}(0≤δ≤1.0), Li_{0.25}Ca_{0.50}TiO_{3-δ}(0≤δ≤1.0), Li_{0.25}Ca_{0.50}FeO_{3-δ}(0≤δ≤1.0), Li_{0.25}Ca_{0.50}PdO_{3-δ}(0≤δ≤1.0), Li_{0.25}Ca_{0.50}PbO_{3-δ}(0≤δ≤1.0), Li_{0.25}Ca_{0.50}RhO_{3-δ}(0≤δ≤1.0), Li_{0.25}Ca_{0.50}SnO_{3-δ}(0≤δ≤1.0), Li_{0.25}Ca_{0.50}VO_{3-δ}(0≤δ≤1.0), Li_{0.25}Ca_{0.50}ReO_{3-δ}(0≤δ≤1.0), Li_{0.25}Ca_{0.50}GeO_{3-δ}(0≤δ≤1.0), Li_{0.25}Ca_{0.50}WO_{3-δ}(0≤δ≤1.0), Li_{0.25}Ca_{0.50}ZrO_{3-δ}(0≤δ≤1.0), Li_{0.25}Ca_{0.50}MoO_{3-δ}(0≤δ≤1.0), Li_{0.25}Ca_{0.50}NbO_{3-δ}(0≤δ≤1.0), Li_{0.25}Ca_{0.50}TaO_{3-δ}(0≤δ≤1.0), Li_{0.25}Ca_{0.50}HfO_{3-δ}(0≤δ≤1.0), Li_{0.25}Ca_{0.50}BiO_{3-δ}(0≤δ≤1.0),

Li_{0.30}Ca_{0.40}TiO_{3-δ}(0≤δ≤1.0), Li_{0.30}Ca_{0.40}MnO_{3-δ}(0≤δ≤1.0), Li_{0.30}Ca_{0.40}NiO_{3-δ}(0≤δ≤1.0), Li_{0.30}Ca_{0.40}CrO_{3-δ}(0≤δ≤1.0), Li_{0.30}Ca_{0.40}CoO_{3-δ}(0≤δ≤1.0), Li_{0.30}Ca_{0.40}IrO_{3-δ}(0≤δ≤1.0), Li_{0.30}Ca_{0.40}RuO_{3-δ}(0≤δ≤1.0), Li_{0.30}Ca_{0.40}TiO_{3-δ}(0≤δ≤1.0), Li_{0.30}Ca_{0.40}FeO_{3-δ}(0≤δ≤1.0), Li_{0.30}Ca_{0.40}PdO_{3-δ}(0≤δ≤1.0), Li_{0.30}Ca_{0.40}PbO_{3-δ}(0≤δ≤1.0), Li_{0.30}Ca_{0.40}RhO_{3-δ}(0≤δ≤1.0), Li_{0.30}Ca_{0.40}SnO_{3-δ}(0≤δ≤1.0), Li_{0.30}Ca_{0.40}VO_{3-δ}(0≤δ≤1.0), Li_{0.30}Ca_{0.40}ReO_{3-δ}(0≤δ≤1.0), Li_{0.30}Ca_{0.40}GeO_{3-δ}(0≤δ≤1.0), Li_{0.30}Ca_{0.40}WO_{3-δ}(0≤δ≤1.0), Li_{0.30}Ca_{0.40}ZrO_{3-δ}(0≤δ≤1.0), Li_{0.30}Ca_{0.40}MoO_{3-δ}(0≤δ≤1.0), Li_{0.30}Ca_{0.40}NbO_{3-δ}(0≤δ≤1.0), Li_{0.30}Ca_{0.40}TaO_{3-δ}(0≤δ≤1.0), Li_{0.30}Ca_{0.40}HfO_{3-δ}(0≤δ≤1.0), Li_{0.30}Ca_{0.40}BiO_{3-δ}(0≤δ≤1.0),

Li_{0.40}Ca_{0.20}TiO₃δ(0≤δ≤1.0), Li_{0.40}Ca_{0.20}MnO_{3-δ}(0≤δ≤1.0), Li_{0.40}Ca_{0.20}NiO_{3-δ}(0≤δ≤1.0), Li_{0.40}Ca_{0.20}CrO_{3-δ}(0≤δ≤1.0), Li_{0.40}Ca_{0.20}CoO_{3-δ}(0≤δ≤1.0), Li_{0.40}Ca_{0.20}IrO_{3-δ}(0≤δ≤1.0), Li_{0.40}Ca_{0.20}RuO_{3-δ}(0≤δ≤1.0), Li_{0.40}Ca_{0.20}TiO_{3-δ}(0≤δ≤1.0), Li_{0.40}Ca_{0.20}FeO_{3-δ}(0≤δ≤1.0), Li_{0.40}Ca_{0.20}PdO_{3-δ}(0≤δ≤1.0), Li_{0.40}Ca_{0.20}PbO_{3-δ}(0≤δ≤1.0), Li_{0.40}Ca_{0.20}RhO_{3-δ}(0≤δ≤1.0), Li_{0.40}Ca_{0.20}SnO_{3-δ}(0≤δ≤1.0), Li_{0.40}Ca_{0.20}VO_{3-δ}(0≤δ≤1.0), Li_{0.40}Ca_{0.20}ReO_{3-δ}(0≤δ≤1.0), Li_{0.40}Ca_{0.20}GeO_{3-δ}(0≤δ≤1.0), Li_{0.40}Ca_{0.20}WO_{3-δ}(0≤δ≤1.0), Li_{0.40}Ca_{0.20}ZrO_{3-δ}(0≤δ≤1.0), Li_{0.40}Ca_{0.20}MoO_{3-δ}(0≤δ≤1.0), Li_{0.40}Ca_{0.20}NbO_{3-δ}(0≤δ≤1.0), Li_{0.40}Ca_{0.20}TaO_{3-δ}(0≤δ≤1.0), Li_{0.40}Ca_{0.20}HfO_{3-δ}(0≤δ≤1.0), Li_{0.40}Ca_{0.20}BiO_{3-δ}(0≤δ≤1.0),

Li_{0.10}Sr_{0.80}TiO_{3-δ}(0≤δ≤1.0), Li_{0.10}Sr_{0.80}MnO_{3-δ}(0≤δ≤1.0), Li_{0.10}Sr_{0.80}NiO_{3-δ}(0≤δ≤1.0), Li_{0.10}Sr_{0.80}CrO_{3-δ}(0≤δ≤1.0), Li_{0.10}Sr_{0.80}CoO_{3-δ}(0≤δ≤1.0), Li_{0.10}Sr_{0.80}IrO_{3-δ}(0≤δ≤1.0), Li_{0.10}Sr_{0.80}RuO_{3-δ}(0≤δ≤1.0), Li_{0.10}Sr_{0.80}TiO_{3-δ}(0≤δ≤1.0), Li_{0.10}Sr_{0.80}FeO_{3-δ}(0≤δ≤1.0), Li_{0.10}Sr_{0.80}PdO_{3-δ}(0≤δ≤1.0), Li_{0.10}Sr_{0.80}PbO_{3-δ}(0≤δ≤1.0), Li_{0.10}Sr_{0.80}RhO_{3-δ}(0≤δ≤1.0), Li_{0.10}Sr_{0.80}SnO_{3-δ}(0≤δ≤1.0), Li_{0.10}Sr_{0.80}VO_{3-δ}(0≤δ≤1.0), Li_{0.10}Sr_{0.80}ReO_{3-δ}(0≤δ≤1.0), Li_{0.10}Sr_{0.80}GeO_{3-δ}(0≤δ≤1.0), Li_{0.10}Sr_{0.80}WO_{3-δ}(0≤δ≤1.0), Li_{0.10}Sr_{0.80}ZrO_{3-δ}(0≤δ≤1.0), Li_{0.10}Sr_{0.80}MoO_{3-δ}(0≤δ≤1.0), Li_{0.10}Sr_{0.80}NbO_{3-δ}(0≤δ≤1.0), Li_{0.10}Sr_{0.80}TaO_{3-δ}(0≤δ≤1.0), Li_{0.10}Sr_{0.80}HfO_{3-δ}(0≤δ≤1.0), Li_{0.10}Sr_{0.80}BiO_{3-δ}(0≤δ≤1.0),

Li_{0.20}Sr_{0.60}TiO_{3-δ}(0≤δ≤1.0), Li_{0.20}Sr_{0.60}MnO_{3-δ}(0≤δ≤1.0), Li_{0.20}Sr_{0.60}NiO_{3-δ}(0≤δ≤1.0), Li_{0.20}Sr_{0.60}CrO_{3-δ}(0≤δ≤1.0), Li_{0.20}Sr_{0.60}CoO_{3-δ}(0≤δ≤1.0), Li_{0.20}Sr_{0.60}IrO_{3-δ}(0≤δ≤1.0), Li_{0.20}Sr_{0.60}RuO_{3-δ}(0≤δ≤1.0), Li_{0.20}Sr_{0.60}TiO_{3-δ}(0≤δ≤1.0), Li_{0.20}Sr_{0.60}FeO_{3-δ}(0≤δ≤1.0), Li_{0.20}Sr_{0.60}PdO_{3-δ}(0≤δ≤1.0), Li_{0.20}Sr_{0.60}PbO_{3-δ}(0≤δ≤1.0), Li_{0.20}Sr_{0.60}RhO_{3-δ}(0≤δ≤1.0), Li_{0.20}Sr_{0.60}SnO_{3-δ}(0≤δ≤1.0), Li_{0.20}Sr_{0.60}VO_{3-δ}(0≤δ≤1.0), Li_{0.20}Sr_{0.60}ReO_{3-δ}(0≤δ≤1.0), Li_{0.20}Sr_{0.60}GeO_{3-δ}(0≤δ≤1.0), Li_{0.20}Sr_{0.60}WO_{3-δ}(0≤δ≤1.0), Li_{0.20}Sr_{0.60}ZrO_{3-δ}(0≤δ≤1.0), Li_{0.20}Sr_{0.60}MoO_{3-δ}(0≤δ≤1.0), Li_{0.20}Sr_{0.60}NbO_{3-δ}(0≤δ≤1.0), Li_{0.20}Sr_{0.60}TaO_{3-δ}(0≤δ≤1.0), Li_{0.20}Sr_{0.60}HfO_{3-δ}(0≤δ≤1.0), Li_{0.20}Sr_{0.60}BiO_{3-δ}(0≤δ≤1.0),

Li_{0.25}Sr_{0.50}TiO_{3-δ}(0≤δ≤1.0), Li_{0.25}Sr_{0.50}MnO_{3-δ}(0≤δ≤1.0), Li_{0.25}Sr_{0.50}NiO_{3-δ}(0≤δ≤1.0), Li_{0.25}Sr_{0.50}CrO_{3-δ}(0≤δ≤1.0), Li_{0.25}Sr_{0.50}CoO_{3-δ}(0≤δ≤1.0), Li_{0.25}Sr_{0.50}IrO_{3-δ}(0≤δ≤1.0), Li_{0.25}Sr_{0.50}RuO_{3-δ}(0≤δ≤1.0), Li_{0.25}Sr_{0.50}TiO_{3-δ}(0≤δ≤1.0), Li_{0.25}Sr_{0.50}FeO_{3-δ}(0≤δ≤1.0), Li_{0.25}Sr_{0.50}PdO_{3-δ}(0≤δ≤1.0), Li_{0.25}Sr_{0.50}PbO_{3-δ}(0≤δ≤1.0), Li_{0.25}Sr_{0.50}RhO_{3-δ}(0≤δ≤1.0), Li_{0.25}Sr_{0.50}SnO_{3-δ}(0≤δ≤1.0), Li_{0.25}Sr_{0.50}VO_{3-δ}(0≤δ≤1.0), Li_{0.25}Sr_{0.50}ReO_{3-δ}(0≤δ≤1.0), Li_{0.25}Sr_{0.50}GeO_{3-δ}(0≤δ≤1.0), Li_{0.25}Sr_{0.50}WO_{3-δ}(0≤δ≤1.0), Li_{0.25}Sr_{0.50}ZrO_{3-δ}(0≤δ≤1.0), Li_{0.25}Sr_{0.50}MoO_{3-δ}(0≤δ≤1.0), Li_{0.25}Sr_{0.50}NbO_{3-δ}(0≤δ≤1.0), Li_{0.25}Sr_{0.50}TaO_{3-δ}(0≤δ≤1.0), Li_{0.25}Sr_{0.50}HfO_{3-δ}(0≤δ≤1.0), Li_{0.25}Sr_{0.50}BiO_{3-δ}(0≤δ≤1.0),

Li_{0.30}Sr_{0.40}TiO_{3-δ}(0≤δ≤1.0), Li_{0.30}Sr_{0.40}MnO_{3-δ}(0≤δ≤1.0), Li_{0.30}Sr_{0.40}NiO_{3-δ}(0≤δ≤1.0), Li_{0.30}Sr_{0.40}CrO_{3-δ}(0≤δ≤1.0), Li_{0.30}Sr_{0.40}CoO_{3-δ}(0≤δ≤1.0), Li_{0.30}Sr_{0.40}IrO_{3-δ}(0≤δ≤1.0), Li_{0.30}Sr_{0.40}RuO_{3-δ}(0≤δ≤1.0), Li_{0.30}Sr_{0.40}TiO_{3-δ}(0≤δ≤1.0), Li_{0.30}Sr_{0.40}FeO_{3-δ}(0≤δ≤1.0), Li_{0.30}Sr_{0.40}PdO_{3-δ}(0≤δ≤1.0), Li_{0.30}Sr_{0.40}PbO_{3-δ}(0≤δ≤1.0), Li_{0.30}Sr_{0.40}RhO_{3-δ}(0≤δ≤1.0), Li_{0.30}Sr_{0.40}SnO_{3-δ}(0≤δ≤1.0), Li_{0.30}Sr_{0.40}VO_{3-δ}(0≤δ≤1.0), Li_{0.30}Sr_{0.40}ReO_{3-δ}(0≤δ≤1.0), Li_{0.30}Sr_{0.40}GeO_{3-δ}(0≤δ≤1.0), Li_{0.30}Sr_{0.40}WO_{3-δ}(0≤δ≤1.0), Li_{0.30}Sr_{0.40}ZrO_{3-δ}(0≤δ≤1.0), Li_{0.30}Sr_{0.40}MoO_{3-δ}(0≤δ≤1.0), Li_{0.30}Sr_{0.40}NbO_{3-δ}(0≤δ≤1.0), Li_{0.30}Sr_{0.40}TaO_{3-δ}(0≤δ≤1.0), Li_{0.30}Sr_{0.40}HfO_{3-δ}(0≤δ≤1.0), Li_{0.30}Sr_{0.40}BiO_{3-δ}(0≤δ≤1.0),

Li_{0.40}Sr_{0.20}TiO_{3-δ}(0≤δ≤1.0), Li_{0.40}Sr_{0.20}MnO_{3-δ}(0≤δ≤1.0), Li_{0.40}Sr_{0.20}NiO_{3-δ}(0≤δ≤1.0), Li_{0.40}Sr_{0.20}CrO_{3-δ}(0≤δ≤1.0), Li_{0.40}Sr_{0.20}CoO_{3-δ}(0≤δ≤1.0), Li_{0.40}Sr_{0.20}IrO_{3-δ(}0≤δ≤1.0), Li_{0.40}Sr_{0.20}RuO_{3-δ}(0≤δ≤1.0), Li_{0.40}Sr_{0.20}TiO_{3-δ}(0≤δ≤1.0), Li_{0.40}Sr_{0.20}FeO_{3-δ}(0≤δ≤1.0), Li_{0.40}Sr_{0.20}PdO_{3-δ}(0≤δ≤1.0), Li_{0.40}Sr_{0.20}PbO_{3-δ}(0≤δ≤1.0), Li_{0.40}Sr_{0.20}RhO_{3-δ}(0≤δ≤1.0), Li_{0.40}Sr_{0.20}SnO_{3-δ}(0≤δ≤1.0), Li_{0.40}Sr_{0.20}VO_{3-δ}(0≤δ≤1.0), Li_{0.40}Sr_{0.20}ReO_{3-δ}(0≤δ≤1.0), Li_{0.40}Sr_{0.20}GeO_{3-δ}(0≤δ≤1.0), Li_{0.40}Sr_{0.20}WO_{3-δ}(0≤δ≤1.0), Li_{0.40}Sr_{0.20}ZrO_{3-δ}(0≤δ≤1.0), Li_{0.40}Sr_{0.20}MoO_{3-δ}(0≤δ≤1.0), Li_{0.40}Sr_{0.20}NbO_{3-δ}(0≤δ≤1.0), Li_{0.40}Sr_{0.20}TaO_{3-δ}(0≤δ≤1.0), Li_{0.40}Sr_{0.20}HfO_{3-δ}(0≤δ≤1.0), Li_{0.40}Sr_{0.20}BiO_{3-δ}(0≤δ≤1.0),

Li_{0.10}Ba_{0.80}TiO_{3-δ}(0≤δ≤1.0), Li_{0.10}Ba_{0.80}MnO_{3-δ}(0≤δ≤1.0), Li_{0.10}Ba_{0.80}NiO_{3-δ}(0≤δ≤1.0), Li_{0.10}Ba_{0.80}CrO_{3-δ}(0≤δ≤1.0), Li_{0.10}Ba_{0.80}CoO_{3-δ}(0≤δ≤1.0), Li_{0.10}Ba_{0.80}IrO_{3-δ}(0≤δ≤1.0), Li_{0.10}Ba_{0.80}RuO_{3-δ}(0≤δ≤1.0), Li_{0.10}Ba_{0.80}TiO_{3-δ}(0≤δ≤1.0), Li_{0.10}Ba_{0.80}FeO_{3-δ}(0≤δ≤1.0), Li_{0.10}Ba_{0.80}PdO_{3-δ}(0≤δ≤1.0), Li_{0.10}Ba_{0.80}PbO_{3-δ}(0≤δ≤1.0), Li_{0.10}Ba_{0.80}RhO_{3-δ}(0≤δ≤1.0), Li_{0.10}Ba_{0.80}SnO_{3-δ}(0≤δ≤1.0), Li_{0.10}Ba_{0.80}VO_{3-δ}(0≤δ≤1.0), Li_{0.10}Ba_{0.80}ReO_{3-δ}(0≤δ≤1.0), Li_{0.10}Ba_{0.80}GeO_{3-δ}(0≤δ≤1.0), Li_{0.10}Ba_{0.80}WO_{3-δ}(0≤δ≤1.0), Li_{0.10}Ba_{0.80}ZrO_{3-δ}(0≤δ≤1.0), Li_{0.10}Ba_{0.80}MoO_{3-δ}(0≤δ≤1.0), Li_{0.10}Ba_{0.80}NbO_{3-δ}(0≤δ≤1.0), Li_{0.10}Ba_{0.80}TaO_{3-δ}(0≤δ≤1.0), Li_{0.10}Ba_{0.80}HfO_{3-δ}(0≤δ≤1.0), Li_{0.10}Ba_{0.80}BiO_{3-δ}(0≤δ≤1.0),

Li_{0.20}Ba_{0.60}TiO_{3-δ}(0≤δ≤1.0), Li_{0.20}Ba_{0.60}MnO_{3-δ}(0≤δ≤1.0), Li_{0.20}Ba_{0.60}NiO_{3-δ}(0≤δ≤1.0), Li_{0.20}Ba_{0.60}CrO_{3-δ}(0≤δ≤1.0), Li_{0.20}Ba_{0.60}CoO_{3-δ}(0≤δ≤1.0), Li_{0.20}Ba_{0.60} IrO_{3-δ}(0≤δ≤1.0), Li_{0.20}Ba_{0.60}RuO_{3-δ}(0≤δ≤1.0), Li_{0.20}Ba_{0.60}TiO_{3-δ}(0≤δ≤1.0), Li_{0.20}Ba_{0.60}FeO_{3-δ}(0≤δ≤1.0), Li_{0.20}Ba_{0.60}PdO_{3-δ}(0≤δ≤1.0), Li_{0.20}Ba_{0.60}PbO_{3-δ}(0≤δ≤1.0), Li_{0.20}Ba_{0.60}RhO_{3-δ}(0≤δ≤1.0), Li_{0.20}Ba_{0.60}SnO_{3-δ}(0≤δ≤1.0), Li_{0.20}Ba_{0.60}VO_{3-δ}(0≤δ≤1.0), Li_{0.20}Ba_{0.60}ReO_{3-δ}(0≤δ≤1.0), Li_{0.20}Ba_{0.60}GeO_{3-δ(}0≤δ≤1.0), Li_{0.20}Ba_{0.60}WO_{3-δ}(0≤δ≤1.0), Li_{0.20}Ba_{0.60}ZrO_{3-δ}(0≤δ≤1.0), Li_{0.20}Ba_{0.60}MoO_{3-δ}(0≤δ≤1.0), Li_{0.20}Ba_{0.60}NbO_{3-δ}(0≤δ≤1.0), Li_{0.20}Ba_{0.60}TaO_{3-δ}(0≤δ≤1.0), Li_{0.20}Ba_{0.60}HfO_{3-δ}(0≤δ≤1.0), Li_{0.20}Ba_{0.60}BiO_{3-δ}(0≤δ≤1.0),

Li_{0.25}Ba_{0.50}TiO_{3-δ}(0≤δ≤1.0), Li_{0.25}Ba_{0.50}MnO_{3-δ}(0≤δ≤1.0), Li_{0.25}Ba_{0.50}NiO_{3-δ}(0≤δ≤1.0), Li_{0.25}Ba_{0.50}CrO_{3-δ}(0≤δ≤1.0), Li_{0.25}Ba_{0.50}CoO_{3-δ}(0≤δ≤1.0), Li_{0.25}Ba_{0.50}IrO_{3-δ}(0≤δ≤1.0), Li_{0.25}Ba_{0.50}RuO_{3-δ}(0≤δ≤1.0), Li_{0.25}Ba_{0.50}TiO_{3-δ}(0≤δ≤1.0), Li_{0.25}Ba_{0.50}FeO_{3-δ}(0≤δ≤1.0), Li_{0.25}Ba_{0.50}PdO_{3-δ}(0≤δ≤1.0), Li_{0.25}Ba_{0.50}PbO_{3-δ}(0≤δ≤1.0), Li_{0.25}Ba_{0.50}RhO_{3-δ}(0≤δ≤1.0), Li_{0.25}Ba_{0.50}SnO_{3-δ}(0≤δ≤1.0), Li_{0.25}Ba_{0.50}VO_{3-δ}(0≤δ≤1.0), Li_{0.25}Ba_{0.50}ReO_{3-δ}(0≤δ≤1.0), Li_{0.25}Ba_{0.50}GeO_{3-δ}(0≤δ≤1.0), Li_{0.25}Ba_{0.50}WO_{3-δ}(0≤δ≤1.0), Li_{0.25}Ba_{0.50}ZrO_{3-δ}(0≤δ≤1.0), Li_{0.25}Ba_{0.50}MoO_{3-δ}(0≤δ≤1.0), Li_{0.25}Ba_{0.50}NbO_{3-δ}(0≤δ≤1.0), Li_{0.25}Ba_{0.50}TaO_{3-δ}(0≤δ≤1.0), Li_{0.25}Ba_{0.50}HfO₃, Li_{0.25}Ba_{0.50}BiO_{3-δ}(0≤δ≤1.0),

Li_{0.30}Ba_{0.40}TiO_{3-δ}(0≤δ≤1.0), Li_{0.30}Ba_{0.40}MnO_{3-δ}(0≤δ≤1.0), Li_{0.30}Ba_{0.40}NiO_{3-δ}(0≤δ≤1.0), Li_{0.30}Ba_{0.40}CrO_{3-δ}(0≤δ≤1.0), Li_{0.30}Ba_{0.40}CoO_{3-δ}(0≤δ≤1.0), Li_{0.30}Ba_{0.40} IrO_{3-δ}(0≤δ≤1.0), Li_{0.30}Ba_{0.40}RuO_{3-δ}(0≤δ≤1.0), Li_{0.30}Ba_{0.40}TiO_{3-δ}(0≤δ≤1.0), Li_{0.30}Ba_{0.40}FeO_{3-δ}(0≤δ≤1.0), Li_{0.30}Ba_{0.40}PdO_{3-δ}(0≤δ≤1.0), Li_{0.30}Ba_{0.40}PbO_{3-δ}(0≤δ≤1.0), Li_{0.30}Ba_{0.40}RhO_{3-δ}(0≤δ≤1.0), Li_{0.30}Ba_{0.40}SnO_{3-δ}(0≤δ≤1.0), Li_{0.30}Ba_{0.40}VO_{3-δ}(0≤δ≤1.0), Li_{0.30}Ba_{0.40}ReO_{3-δ}(0≤δ≤1.0), Li_{0.30}Ba_{0.40}GeO_{3-δ}(0≤δ≤1.0), Li_{0.30}Ba_{0.40}WO_{3-δ}(0≤δ≤1.0), Li_{0.30}Ba_{0.40}ZrO_{3-δ}(0≤δ≤1.0), Li_{0.30}Ba_{0.40}MoO_{3-δ}(0≤δ≤1.0), Li_{0.30}Ba_{0.40}NbO_{3-δ}(0≤δ≤1.0), Li_{0.30}Ba_{0.40}TaO_{3-δ}(0≤δ≤1.0), Li_{0.30}Ba_{0.40}HfO_{3-δ}(0≤δ≤1.0), Li_{0.30}Ba_{0.40}BiO_{3-δ}(0≤δ≤1.0),

Li_{0.40}Ba_{0.20}TiO_{3-δ}(0≤δ≤1.0), Li_{0.40}Ba_{0.20}MnO_{3-δ}(0≤δ≤1.0), Li_{0.40}Ba_{0.20}NiO_{3-δ}(0≤δ≤1.0), Li_{0.40}Ba_{0.20}CrO_{3-δ}(0≤δ≤1.0), Li_{0.40}Ba_{0.20}CoO_{3-δ}(0≤δ≤1.0), Li_{0.40}Ba_{0.20}IrO_{3-δ}(0≤δ≤1.0), Li_{0.40}Ba_{0.20}RuO_{3-δ}(0≤δ≤1.0), Li_{0.40}Ba_{0.20}TiO_{3-δ}(0≤δ≤1.0), Li_{0.40}Ba_{0.20}FeO_{3-δ}(0≤δ≤1.0), Li_{0.40}Ba_{0.20}PdO_{3-δ}(0≤δ≤1.0), Li_{0.40}Ba_{0.20}PbO_{3-δ}(0≤δ≤1.0), Li_{0.40}Ba_{0.20}RhO_{3-δ}(0≤δ≤1.0), Li_{0.40}Ba_{0.20}SnO_{3-δ}(0≤δ≤1.0), Li_{0.40}Ba_{0.20}VO_{3-δ}(0≤δ≤1.0), Li_{0.40}Ba_{0.20}ReO_{3-δ}(0≤δ≤1.0), Li_{0.40}Ba_{0.20}GeO_{3-δ}(0≤δ≤1.0), Li_{0.40}Ba_{0.20}WO_{3-δ}(0≤δ≤1.0), Li_{0.40}Ba_{0.20}ZrO_{3-δ}(0≤δ≤1.0), Li_{0.40}Ba_{0.20}MoO_{3-δ}(0≤δ≤1.0), Li_{0.40}Ba_{0.20}NbO_{3-δ}(0≤δ≤1.0), Li_{0.40}Ba_{0.20}TaO_{3-δ}(0≤δ≤1.0), Li_{0.40}Ba_{0.20}HfO_{3-δ}(0≤δ≤1.0), Li_{0.40}Ba_{0.20}BiO_{3-δ}(0≤δ≤1.0),

Li_{0.25}La_{0.50}TiO_{3-δ}(0≤δ≤1.0), Li_{0.25}La_{0.50}MnO_{3-δ}(0≤δ≤1.0), Li_{0.25}La_{0.50}NiO_{3-δ}(0≤δ≤1.0), Li_{0.25}La_{0.50}CrO_{3-δ}(0≤δ≤1.0), Li_{0.25}La_{0.50}CoO_{3-δ}(0≤δ≤1.0), Li_{0.25}La_{0.50}IrO_{3-δ}(0≤δ≤1.0), Li_{0.25}La_{0.50}RuO_{3-δ}(0≤δ≤1.0), Li_{0.25}La_{0.50}TiO_{3-δ}(0≤δ≤1.0), Li_{0.25}La_{0.50}FeO_{3-δ}(0≤δ≤1.0), Li_{0.25}La_{0.50}PdO_{3-δ}(0≤δ≤1.0), Li_{0.25}La_{0.50}PbO_{3-δ}(0≤δ≤1.0), Li_{0.25}La_{0.50}RhO_{3-δ}(0≤δ≤1.0), Li_{0.25}La_{0.50}SnO_{3-δ}(0≤δ≤1.0), Li_{0.25}La_{0.50}VO_{3-δ}(0≤δ≤1.0), Li_{0.25}La_{0.50}ReO_{3-δ}(0≤δ≤1.0), Li_{0.25}La_{0.50}GeO_{3-δ}(0≤δ≤1.0), Li_{0.25}La_{0.50}WO_{3-δ}(0≤δ≤1.0), Li_{0.25}La_{0.50}ZrO_{3-δ}(0≤δ≤1.0), Li_{0.25}La_{0.50}MoO_{3-δ}(0≤δ≤1.0), Li_{0.25}La_{0.50}NbO_{3-δ}(0≤δ≤1.0), Li_{0.25}La_{0.50}TaO_{3-δ}(0≤δ≤1.0), Li_{0.25}La_{0.50}HfO_{3-δ}(0≤δ≤1.0), Li_{0.25}La_{0.50}BiO_{3-δ}(0≤δ≤1.0),

Li_{0.05}La_{0.82}Ti_{0.70}O_{3-δ}(0≤δ≤1.0), Li_{0.05}La_{0.82}Mn_{0.70}O_{3-δ}(0≤δ≤1.0), Li_{0.10}La_{0.80}Mn_{0.70}O_{3-δ}(0≤δ≤1.0), Li_{0.20}La_{0.77}Mn_{0.70}O_{3-δ}(0≤δ≤1.0), Li_{0.05}La_{0.82}Nb_{0.70}O_{3-δ}(0≤δ≤1.0), Li_{0.10}La_{0.80}Nb_{0.70}O_{3-δ}(0≤δ≤1.0), Li_{0.20}La_{0.77}Nb_{0.70}O_{3-δ}(0≤δ≤1.0), Li_{0.05}La_{0.82}Ta_{0.70}O_{3-δ}(0≤δ≤1.0), Li_{0.10}La_{0.80}Ta_{0.70}O_{3-δ}(0≤δ≤1.0), Li_{0.20}La_{0.77}Ta_{0.70}O_{3-δ}(0≤δ≤1.0), Li_{0.05}La_{0.82}V_{0.70}O_{3-δ}(0≤δ≤1.0), Li_{0.05}La_{0.82}V_{0.70}O_{3-δ}(0≤δ≤1.0), Li_{0.20}La_{0.77}V_{0.70}O_{3-δ}(0≤δ≤1.0), Li_{0.05}La_{0.82}W_{0.70}O_{3-δ}(0≤δ≤1.0), Li_{0.10}La_{0.80}W_{0.70}O_{3-δ}(0≤δ≤1.0), Li_{0.20}La_{0.77}W_{0.70}O_{3-δ}(0≤δ≤1.0), Li_{0.05}La_{0.82}Mo_{0.70}O_{3-δ}(0≤δ≤1.0), Li_{0.10}La_{0.80}Mo_{0.70}O_{3-δ}(0≤δ≤1.0), Li_{0.20}La_{0.77}Mo_{0.70}O_{3-δ}(0≤δ≤1.0), Li_{0.05}La_{0.82}Bi_{0.70}O_{3-δ}(0≤δ≤1.0), Li_{0.10}La_{0.80}Bi_{0.70}O_{3-δ}(0≤δ≤1.0), Li_{0.20}La_{0.77}Bi_{0.70}O_{3-δ}(0≤δ≤1.0), Li_{0.05}La_{0.82}Cr_{0.70}O_{3-δ}(0≤δ≤1.0), Li_{0.10}La_{0.80}Cr_{0.70}O_{3-δ}(0≤δ≤1.0), or Li_{0.20}La_{0.77}Cr_{0.70}O_{3-δ}(0≤δ≤1.0).

The perovskite compound may be, for example, Li_{0.30}La_{0.56}TiO₃, Li_{0.34}La_{0.55}RuO₃, Li_{0.2}Ca_{0.6}Mn_{0.5}Ni_{0.5}O₃, Li_{0.34}La_{0.55}RuO_{3-δ}, Li_{0.2}Ca_{0.6}Mn_{0.5}Ni_{0.5}O_{3-δ}, or the like, but is not limited thereto. Any suitable material including lithium and available as a perovskite compound in the art may be used.

The perovskite compound may have, for example, electronic conductivity of 1.0×10⁻⁹ S/cm or greater and ionic conductivity of 2.0×10⁻⁷ S/cm or greater.

The electronic conductivity of the perovskite compound may be, for example, 5.0×10⁻⁸ S/cm or greater, 1.0×10⁻⁷ S/cm or greater, 5.0×10⁻⁷ S/cm or greater, 1.0×10⁻⁶ S/cm or greater, 5.0×10⁻⁶ S/cm or greater, 1.0×10⁻⁵ S/cm or greater, 5.0×10⁻⁵ S/cm or greater, 1.0×10⁻⁴ S/cm or greater, 5.0×10⁻⁴ S/cm or greater, or 1.0×10⁻³ S/cm or greater, about 5.0×10⁻⁹ S/cm to about 10⁻¹ S/cm, about 1.0×10⁻⁸ S/cm to about 10⁻¹ S/cm, about 5.0×10⁻⁸ S/cm to about 10⁻¹ S/cm, about 1.0×10⁻⁷ S/cm to about 10⁻¹ S/cm, about 5.0×10⁻⁷ S/cm to about 10⁻¹ S/cm, about 1.0×10⁻⁶ S/cm to about 10⁻¹ S/cm, about 5.0×10⁻⁶ S/cm to about 10⁻¹ S/cm, about 1.0×10⁻⁵ S/cm to about 10⁻¹ S/cm, about 5.0×10⁻⁵ S/cm to about 10⁻¹ S/cm, about 1.0×10⁻⁴ S/cm to about 10⁻¹ S/cm, about 5.0×10⁻⁴ S/cm to about 10⁻¹ S/cm, or about 1.0×10⁻³ S/cm to about 10⁻¹ S/cm. When the perovskite compound has such high electronic conductivity, a cathode including the perovskite compound and a lithium air battery including the cathode may each have reduced internal resistance.

The ionic conductivity of the perovskite compound may be, for example, 5.0×10⁻⁷ S/cm or greater, 1.0×10⁻⁶ S/cm or greater, 5.0×10⁻⁶ S/cm or greater, or 1.0×10⁻⁵ S/cm or greater, about 5.0×10⁻⁸ S/cm to about 10⁻³ S/cm, about 1.0×10⁻⁷ S/cm to about 10⁻³ S/cm, about 5.0×10⁻⁷ S/cm to about 10⁻³ S/cm, about 1.0×10⁻⁶ S/cm to about 10⁻³ S/cm, about 5.0×10⁻⁶ S/cm to about 10⁻³ S/cm, or about 1.0×10⁻⁵ S/cm to about 10⁻³ S/cm. When the perovskite compound has such high ionic conductivity, a cathode including the spinel compound and a lithium battery including the cathode may each have further reduced internal resistance.

The cathode mixed conductor may include, for example, a layered compound represented by Formula 9:

Li_{1±x}M_{1±y}O_{2±-δ} Formula 9

In Formula 9, M may be at least one metal element belonging to Groups 2 to 16 of the Periodic Table of Elements, δ may indicate an oxygen vacancy content, 0<x<0.5, 0<y<1, and 0≤δ≤1.

The layered compound may be a compound having a layered crystalline structure.

The layered compound may be, for example, represented by one of the following formulae: LiₐA_{1-b}B′_{b}D₂ (wherein 0.90≤a≤1.8 and 0≤b≤0.5); LiₐE_{1-b}B′_{b}O_{2-c}D_{c} (wherein 0.90≤a≤1.8, 0≤b≤0.5, and 0≤c≤0.05); LiE_{2-b}B′_{b}O_{4-c}D_{c} (wherein 0≤b≤0.5 and 0≤c≤0.05); LiₐNi_{1-b-c}CO_{b}B′_{c}Dₐ (wherein 0.90≤a≤1.8, 0≤b≤0.5, 0≤c≤0.05, and 0<α≤2); LiₐNi_{1-b-c}Co_{b}B′_{c}O_{2-α}F_{α} (wherein 0.90≤a≤1.8, 0≤b≤0.5, 0≤c≤0.05, and 0<α<2); LiₐNi_{1-b-c}Co_{b}B′_{c}O_{2-α}F₂ (wherein 0.90≤a≤1.8, 0≤b≤0.5, 0≤c≤0.05, and 0<α<2); LiₐNi_{1-b-c}Mn_{b}B′_{c}D_{α} (wherein 0.90≤a≤1.8, 0≤b≤0.5, 0≤c≤0.05, and 0<α≤2); LiₐNi_{1-b-c}Mn_{b}B′_{c}O_{2-α}F′_{α} (wherein 0.90≤a≤1.8, 0≤b≤0.5, 0≤c≤0.05, and 0<α<2); LiₐNi_{1-b-c}Mn_{b}B′_{c}O_{2-α}F′₂ (wherein 0.90≤a≤1.8, 0≤b≤0.5, 0≤c≤0.05, and 0<α<2); LiₐNi_{b}E_{c}G_{d}O₂ (wherein 0.90≤a≤1.8, 0≤b≤0.9, 0≤c≤0.5, and 0.001≤d≤0.1); LiₐNi_{b}Co_{c}Mn_{d}GeO₂ (wherein 0.90≤a≤1.8, 0≤b≤0.9, 0≤c≤0.5, 0≤d≤0.5, and 0.001≤e≤0.1); LiₐNiG_{b}O₂ (wherein 0.90≤a≤1.8 and 0.001≤b≤0.1); LiₐCoG_{b}O₂ (wherein 0.90≤a≤1.8 and 0.001≤b≤0.1); or LiₐMnG_{b}O₂ (wherein 0.90≤a≤1.8 and 0.001≤b≤0.1). In the above layered compound formulas, A, B′, E, F′, D, and G are each independently an element of Groups 2 to 17 of the Periodic Table of Elements.

The layered compound may be, for example, LiNiO₂, LiCoO₂, LiMnO₂, LiNi₁₋ₓMnₓO₂ (wherein 0<x<1), LiNi_{1-x-y}CoₓMn_{y}O₂ (wherein 0<x≤0.5 and 0<y≤0.5), LiNi_{0.8}Co_{0.1}Mn_{0.1}O₂, LiNi_{1-x-y}CoₓAl_{y}O₂ (where 0<x≤0.5 and 0<y≤0.5), or the like, but is not limited thereto. Any suitable material including lithium and available as a layered compound in the art may be used.

The cathode mixed conductor may include, for example, an NASICON compound represented by Formula 10:

Li₁₊ₓAₓM₂₋ₓ(XO₄)₃Formula 10.

In Formula 10, A and M may each independently be at least one metal element belonging to Groups 2 to 16 of the Periodic Table of Elements, X may be As, P, Mo, or S, and 0<x<1.

The NASICON may be a compound having an NASICON crystalline structure or an NASICON-like crystalline structure.

The NASICON compound may be, for example, Li_{1.3}Al_{0.3}Ti_{1.7}(PO₄)₃, Li_{1.3}Al_{0.3}Ge_{1.7}(PO₄)₃, Li_{1.3}Al_{0.3}Zr_{1.7}(PO₄)₃, or the like, but is not limited thereto. Any suitable material including lithium and available as an NASICON compound in the art may be used.

The cathode mixed conductor may include, for example, a LISICON compound represented by Formula 11.

Li_{8-c}AₐM_{b}O₄ Formula 11

In Formula 11, A and M may each independently be at least one metal element belonging to Groups 2 to 16 of the Periodic Table of Elements, c is (ma+nb), m may indicate an oxidation number of A, n may indicate an oxidation number of M, 0<x<8, 0<a≤1, and 0≤b≤1.

The LISICON compound may have a LISICON crystalline structure or a LISICON-like crystalline structure.

The LISICON compound may be, for example, Li₄SiO₄, Li_{3.75}Si_{0.75}P_{0.25}O₄, Li₁₄Zn(GeO₄)₄, Li_{3.4}V_{0.6}Ge_{0.4}O₄, or Li_{3.5}V_{0.5}Ti_{0.5}O₄, but is not limited thereto. Any suitable material including lithium and available as a LISICON compound may be used.

The cathode mixed conductor may include, for example, a garnet compound represented by Formula 12:

LiₓA₃M₂O₁₂ Formula 12.

In Formula 12, A and M may each independently be at least one metal element belonging to Groups 2 to 16 of the Periodic Table of Elements, and 3≤x≤7.

The garnet compound may have a garnet crystalline structure or a garnet-like crystalline structure.

The garnet compound may be, for example, Li₃Tb₃Te₂O₁₂, Li_{4.22}Al_{0.26}La₃Zr₂WO₁₂, Li₅La₃Nb₂O₁₂, Li₆BaLa₂Ta₂O₁₂, or Li₇La₃Zr₂O₁₂, but is not limited thereto. Any suitable material including lithium and available as a garnet compound may be used.

The cathode mixed conductor may include, for example, a phosphate compound represented by Formula 13 or Formula 14:

Li_{1±x}MPO₄ Formula 13, or

Li₂MP₂O₇ Formula 14.

In Formula 13 and Formula 14, M may be at least one metal element belonging to Groups 2 to 16 of the Periodic Table of Elements, and 0≤x≤1.

The compound represented by Formula 13 may be an olivine compound. The olivine compound may have an olivin crystalline or an olivine-like crystalline structure.

The phosphate compound may be, for example, LiFePO₄, LiMnPO₄, LiCoPO₄, LiNiPO₄, Li₂MnP₂O₇, or Li₂FeP₂O₇, but is not limited thereto. Any suitable material including lithium and available as a phosphate compound may be used.

The cathode mixed conductor may include, for example, a tavorite compound or a triplite compound, each represented by Formula 15:

Li_{1±x}M(TO₄)X Formula 15.

In the formula above, M may be at least one metal element belonging to Groups 2 to 16 of the Periodic Table of Elements, T may be P or S, X may be F, O, or OH, and 0≤x≤1.

The tavorite compound may have a tavorite crystalline structure or a tavorite-like crystalline structure. The triplite compound may have a triplite crystalline structure or a triplite-like crystalline structure.

The tavorite compound or the triplite compound may be, for example, LiVO(PO₄), LiV(PO₄)F, LiFe(SO₄)F, or Li₂Fe(PO₄)F, but is not limited thereto. Any suitable material including lithium and available as a tavorite compound or a triplite compound may be used. The tavorite compound or the triplite compound may have the same composition, but different crystalline structure from each other.

The cathode mixed conductor may include, for example, an anti-perovskite compound represented by Formula 16:

LiₓM_{y}OA Formula 16.

In Formula 16, M may be at least one metal element belonging to Groups 2 to 16 of the Periodic Table of Elements, A may be F, Cl, Br, I, S, Se, or Te, 2.0≤x≤3, and 0≤y≤1.

The anti-perovskite compound may have a perovskite crystalline structure or a perovskite-like crystalline structure, wherein the positions of cations and anions are opposite to those of cations and anions of the perovskite compound.

The anti-perovskite compound may be, for example, Li₃OCl, Li₂OHBr, Li₂(OH)_{0.9}F_{0.1}Cl, or Li₃OCl_{0.5}Br_{0.5}, but is not limited thereto. Any suitable material including lithium and available as an anti-perovskite compound may be used.

The cathode mixed conductor may include, for example, at least one of silicate compounds represented by Formula 17:

Li_{2±x}MSiO₄ Formula 17.

In Formula 17, M may be at least one metal element belonging to Groups 2 to 16 of the Periodic Table of Elements, and 0≤x≤1.

The silicate compound may be a crystalline compound including SiO₄⁴⁻ anions.

The silicate compound may be, for example, Li₂MnSiO₄, Li₂FeSiO₄, or the like, but is not limited thereto. Any suitable material including lithium and available as a silicate compound may be used.

The cathode mixed conductor may include, for example, at least one of borate compounds represented by Formula 18:

Li_{1±x}MBO₃ Formula 18.

In Formula 18, M may be at least one metal element belonging to Groups 2 to 16 of the Periodic Table of Elements, and 0≤x≤1.

The silicate compound be a crystalline compound including BO₃³⁻ anions.

The borate compound may be, for example, LiFeBO₃, LiCoBO₃, or the like, but is not limited thereto. Any suitable material including lithium and available as a borate compound may be used.

The layered compound represented by Formula 9, the NASICON compound represented by Formula 10, the LISICON compound represented by Formula 11, the garnet compound represented by Formula 12, the phosphate compound represented by Formula 13 or 14, the tavorite compound represented by Formula 15, the anti-perovskite represented by Formula 16, a silicate compound represented by Formula 18 May Each have the Ionic Conductivity of, for Example, 1.0×10⁻⁸ S/Cm or Greater, 5.0×10⁻⁸ S/cm or greater, 5.0×10⁻⁷ S/cm or greater, 1.0×10⁻⁶ S/cm or greater, 5.0×10⁻⁶ S/cm or greater, or 1.0×10⁻⁵ S/cm or greater, about 5.0×10⁻⁸ S/cm to about 10⁻³ S/cm, about 1.0×10⁻⁷ S/cm to about 10⁻³ S/cm, about 5.0×10⁻⁷ S/cm to about 10⁻³ S/cm, about 1.0×10⁻⁶ S/cm to about 10⁻³ S/cm, about 5.0×10⁻⁶ S/cm to about 10⁻³ S/cm, or about 1.0×10⁻⁵ S/cm to about 10⁻³ S/cm. When these compounds of Formulae 9 to 18 each have such high ionic conductivity, a cathode including the compounds of Formulae 9 to 18 and a lithium air battery may each have further reduced internal resistance.

The cathode mixed conductor may be, for example, a lithium ion conductor that is electrochemically stable against lithium metal at a voltage of 4.2 V or greater.

The cathode mixed conductor may be, for example, stable against lithium metal at a voltage in a range of 2.0 V to 4.2 V, or 2.4 V to 4.2 V, each versus Li/Li⁺.

The cathode may be, for example, porous. When the cathode is porous, air, oxygen, or the like may be easily diffused into the cathode.

According to another aspect of the present disclosure, a lithium air battery includes the cathode; an anode including lithium; and an electrolyte between the cathode and the anode.

When the lithium air battery includes a cathode including the cathode mixed conductor and the additive that are described above, the lithium air battery may have improved structural stability as well as improved capacity and lifespan characteristics.

The lithium air battery includes the cathode, and the cathode may be an air electrode. The cathode may be, for example, disposed on a cathode current collector.

The cathode may include the cathode mixed conductor and the additive. The amount of the cathode mixed conductor may be, for example, in a range of about 50 parts by weight to about 99.99 parts by weight, about 60 parts by weight to about 99.99 parts by weight, about 70 parts by weight to about 99.99 parts by weight, or about 70 parts by weight to about 99.97 parts by weight, based on 100 parts by weight of the cathode, and the amount of the additive is the same as described. When preparing the cathode, a pore-forming agent may be introduced to introduce pores into the cathode. The cathode may be, for example, porous. The cathode may be in the form of, for example, porous pellets, porous sheets, or the like. However, the form of the cathode is not limited thereto, and the cathode may be molded according to the required battery shape. When the cathode includes the cathode mixed conductor and the additive, a structure of the cathode may be simplified and a process of manufacturing the cathode may be also simplified. The cathode may be, for example, transparent to gases such as oxygen, air, or the like. Therefore, the cathode may be substantially impermeable to gases such as oxygen, air, or the like, and is distinguished from the cathode in the art that conducts ions only. When the cathode is porous and/or gas-permeable, oxygen, air, or the like may be easily diffused into the cathode, and through the cathode mixed conductor included in the cathode, lithium ions and/or electrons may be easily transferred, thereby facilitating an electrochemical reaction upon oxygen, lithium ions, and electrons in the cathode.

In an embodiment, the cathode may further include, for example, another cathode material in addition to the cathode mixed conductor and the additive.

The cathode may include, for example, a conductive material, and the conductive may be, for example, porous. The porosity of the conductive material facilitates penetration of air, and any suitable material having porosity and/or conductivity and available in the art may be used as the conductive material. For example, the conductive material may be a carbon-based material having porosity, and examples of the carbon-based material include carbon black, graphite, graphene, activated carbon, carbon fiber, and the like, but are not limited thereto. Any suitable material available as a carbon-based material in the art may be used. The conductive material may be, for example, a metallic material, and examples of the metallic material include metallic fiber, metallic mesh, metallic powder, and the like. The metallic powder may be, for example, copper powder, silver powder, nickel powder, aluminum powder, and the like. The conductive material may be, for example, an organic conductive material. The organic conductive material may be, for example, a polyphenylene derivative, a polythiophene derivative, or the like. The conductive materials may be used, for example, alone or in combination. The cathode may include, as the conductive material, the cathode mixed conductor, and may further include the above-described conductive material in addition to the cathode mixed conductor.

The cathode may further include, for example, a catalyst for oxidation/reduction of oxygen. The catalyst may be, for example: a metal, such as at least one of platinum, gold, silver, palladium, ruthenium, rhodium, or osmium; an oxide catalyst, such as manganese oxide, iron oxide, cobalt oxide, and nickel oxide; or an organometallic catalyst such as cobalt phthalocyanine, but is not limited thereto. Any suitable material available as a catalyst for oxidation/reduction of oxygen in the art may be used. A combination comprising at least one of the foregoing may be used.

The catalyst may be, for example, supported on a carrier. Examples of the carrier include an oxide carrier, a zeolite carrier, a clay-based mineral carrier, or a carbon carrier. The oxide carrier may be, for example, a metal oxide carrier including at least one metal of Al, Si, Zr, Ti, Ce, Pr, Sm, Eu, Tb, Tm, Yb, Sb, Bi, V, Cr, Mn, Fe, Co, Ni, Cu, Nb, Mo, or W. Examples of the oxide carrier include alumina, silica, zirconium oxide, titanium dioxide, and the like. The carbon carrier may be, for example, carbon black, such as ketjen black, acetylene black, channel black, lamp black, and the like; graphite, such as natural graphite, artificial graphite, expanded graphite, and the like; activated carbon; carbon fiber; and the like, but is not limited thereto. Any suitable material available as a carrier in the art may be used.

The cathode may further include, for example, a binder. The binder may include, for example, a thermoplastic resin or a thermosetting resin. Examples of the binder include at least one of polyethylene, polypropylene, polytetrafluoro ethylene (PTFE), polyvinylidene fluoride (PVDF), a styrene-butadiene rubber, a tetrafluoroethylene-perfluoroalkyl vinyl ether copolymer, a vinylidene fluoride-hexafluoropropylene copolymer, a vinylidene fluoride-chlorotrifluoro ethylene copolymer, an ethylene-tetrafluoro ethylene copolymer, polychlorotrifluoroethylene, a vinylidene fluoride-pentafluoro propylene copolymer, a propylene-tetrafluoroethylene copolymer, an ethylene-chlorotrifluoro ethylene copolymer, a vinylidene fluoride-hexafluoropropylene-tetrafluoro ethylene copolymer, a vinylidene fluoride-perfluoromethyl vinylether-tetrafluoro ethylene copolymer, or an ethylene-acrylic acid copolymer, which may be used alone or in combination. The examples of the binder are not limited thereto, and any suitable material available as the binder in the art may be used.

The cathode may be, for example, prepared as follows. A cathode slurry may be prepared by mixing the conductive material, the catalyst for oxidation/reduction of oxygen, and the binder and adding a suitable solvent to the mixture. Then, the cathode slurry may be coated on a surface of a substrate and dried, or may be subjected to compression molding to improve the electrode density. Here, the substrate may be, for example, a cathode current collector, a separator, or a solid electrolyte membrane. The cathode current collector may be, for example, a gas diffusion layer. The conductive material may include the cathode mixed conductor, and the catalyst for oxidation/reduction of oxygen and the binder may be omitted when preparing the cathode depending on a type of a cathode to be prepared.

The lithium air battery may include an anode, and the anode may include lithium.

The anode may be, for example, a lithium metal thin film or a lithium-based alloy thin film. The lithium-based alloy thin film may be, for example, an alloy of lithium and aluminum, tin, magnesium, indium, calcium, titanium, vanadium, or the like.

The lithium air battery may include an electrolyte that is disposed between the cathode and the anode.

The electrolyte may include at least one electrolyte of a solid electrolyte, a gel electrolyte, or a liquid electrolyte. The solid electrolyte, the gel electrolyte, or the liquid electrolyte are not particularly limited, and any suitable material available as the electrolyte in the art may be used.

For example, the electrolyte may include a solid electrolyte.

A solid electrolyte may include at least one of a solid electrolyte including an ionically conducting inorganic material, a solid electrolyte including a polymeric ionic liquid (PIL) and a lithium salt, a solid electrolyte including an ionically conducting polymer and a lithium salt, or a solid electrolyte including an electronically conducting polymer, but is not limited thereto. Any suitable material available as a solid electrolyte in the art may be used.

The ionically conducting inorganic material may include at least one of a glass or amorphous metal-ionically conducting material, a ceramic-activated metal-ionically conducting material, and a glass ceramic-activated metal-ionically conducting material, but is not limited thereto. Any suitable material available as the ionically conducting inorganic material in the art may be used. The ionically conducting inorganic material may be, for example, an ionically conducting inorganic particle or a molded article in the sheet form thereof.
Examples of the ionically conducting inorganic material are BaTiO₃, Pb(ZrₐTi₁₋ₐ)O₃ 0≤a≤1 (PZT), Pb_{1-x′}La_{x′}Zr_{1-y′}Ti_{y′}O₃ (PLZT)(0≤x′≤1, 0≤y′≤1), Pb(Mg₃Nb_{2/3})O₃—PbTiO₃ (PMN-PT), HfO₂, SrTiO₃, SnO₂, CeO₂, Na₂O, MgO, NiO, CaO, BaO, ZnO, ZrO₂, Y₂O₃, Al₂O₃, TiO₂, SiO₂, SiC, lithium phosphate (Li₃PO₄), lithium titanium phosphate (Li_{x′}Ti_{y′}(PO₄)₃, 0≤x′≤2, 0≤y′≤3), lithium aluminum titanium phosphate (Li_{x′}Al_{y′}Ti_{z′}(PO₄)₃, 0<x′<2, 0<y′<1, 0<z′<3), Li_{1+x′+y′}(AlₐGa₁₋ₐ)_{x′}(Ti_{b}Ge_{1-b})_{2-x′}Si_{y′}P_{3-y′}O₁₂ (0≤x′≤1, 0≤y′≤1, 0≤a≤1, 0≤b≤1), lithium lanthanum titanate (Li_{x′}La_{y′}, TiO₃, 0<x′<2, 0<y′<3), lithium germanium thiophosphate (Li_{x′}Ge_{y′}P_{z′}S_{w′}, 0<x′<4, 0<y′<1, 0<z′<1, 0<w′<5), lithium nitride (Li_{x′}N_{y′}, 0<x′<4, 0<y′<2), SiS₂(Li_{x′}Si_{y′}S_{z′}, 0<x′<3, 0<y′<2, 0<z′<4) glass, P₂S₅(Li_{x′}P_{y′}S_{z′}, 0<x′<3, 0<y′<3, 0<z′<7) glass, Li₂O, LiF, LiOH, Li₂CO₃, LiAlO₂, Li₂O—Al₂O₃—SiO₂—P₂O₅—TiO₂—GeO₂ ceramic, or a garnet ceramic (Li₃₊ₓLa₃M₂O₁₂(M=Te, Nb, Zr))(0≤x′≤1), or any suitable combination thereof.

In an embodiment, the solid electrolyte may be an ionically conducting lithium glass, an ionically conducting lithium crystal (ceramic or glass-ceramic), or a mixture thereof. In consideration of chemical stability, the solid electrolyte may include oxide. When the solid electrolyte includes a large amount of ionically conducting lithium crystals, a high ionic conductivity may be obtained. For example, the amount of the ionically conducting lithium crystal may be, for example, about 50 weight % or greater, 55 weight % or greater, or about 60 weight % or greater, based on the total weights of the solid electrolyte. The ionically conducting lithium crystal may be, for example, a crystal with a perovskite structure having ionic conductivity, such as Li₃N, LISICON, La_{0.55}Li_{0.35}TiO₃, or the like, LiTi₂P₃O₁₂ with an NASICON structure, or a glass-ceramic that precipitates crystals above. Examples of the ionically conducting lithium crystal are Li_{1+x+y}(AlₐGa₁₋ₐ)ₓ(Ti_{b}Ge_{1-b})₂₋ₓSi_{y}P_{3-y}O₁₂ (where 0≤x≤1, 0≤y≤1, for example, 0≤x≤0.4 and 0<y≤0.6, or 0.1≤x≤0.3 and 0.1<y≤0.4, 0≤a≤1, and 0≤b≤1). In order for the ionically conducting lithium crystal have high ionic conductivity, the ionically conducting lithium crystal should not have grain boundaries that do not interfere with ion conduction. For example, the glass-ceramic have few pores or grain boundaries that interfere with ion conduction, and thus, high ion conduction and improved chemical stability may be obtained. Examples of the ionically conducting lithium glass-ceramic are lithium-aluminum-germanium-phosphate (LAGP), lithium-aluminum-titanium-phosphate (LATP), lithium-aluminum-titanium-silicon-phosphate (LATSP), and the like. For example, a mother glass may have a composition of Li₂O—Al₂O₃—TiO₂—SiO₂—P₂O₅, and when thermally treated, a main crystal phase may be Li_{1+x+y}AlₓTi₂₋ₓSi_{y}P_{3-y}O₁₂ (0≤x≤2, 0≤y≤3), wherein x and y may be, for example, 0≤x≤0.4 and 0<y≤0.6, or 0.1≤x≤0.3 and 0.1<y≤0.4. The term ‘pore or grain boundary that interferes with ion conduction’ as used herein refers to an ion conduction inhibitory material, such as a pore or a grain boundary) that reduces the entire conductivity of an inorganic material including a lithium ionically conducting crystal to a value of 1/10 or less of the entire conductivity of the lithium ionically conducting crystal in the inorganic material.

For example, the solid electrolyte may include at least one of LAGP, LATP, and LATSP.

The polymeric ionic liquid (PIL) may include, for example, i) at least one cation of an ammonium-based cation, a pyrrolidinium-based cation, a pyridinium-based cation, a pyrimidinium-based cation, an imidazolium-based cation, a piperidinium-based cation, a pyrazolium-based cation, an oxazolium-based cation, a pyridazinium-based cation, a phosphonium-based cation, a sulfonium-based cation, or a triazole-based cation, and ii) at least one anion of BF₄⁻, PF₆⁻, AsF₆⁻, SbF₆⁻, AlCl₄⁻, HSO₄⁻, ClO₄⁻, CH₃SO₃⁻, CF₃CO₂⁻, N(CF₃SO₂)₂⁻, Cl⁻, Br⁻, I⁻, SO₄⁻, CF₃SO₃⁻, N(C₂F₅SO₂)₂⁻, N(C₂F₅SO₂)(CF₃SO₂)⁻, NO₃⁻, Al₂Cl₇⁻, CF₃COO⁻, CH₃COO⁻, (CF₃SO₂)₃C⁻, (CF₃)₂PF₄⁻, (CF₃)₃PF₃⁻, (CF₃)₄PF₂⁻, (CF₃)₅PF⁻, (CF₃)₆P⁻, SF₅CF₂SO₃⁻, SF₅CHFCF₂SO₃⁻, CF₃CF₂(CF₃)₂CO⁻, (CF₃SO₂)₂CH⁻, (SF₅)₃C⁻, or (O(CF₃)₂C₂(CF₃)₂O)₂PO. The PIL may be, for example, at least one of poly(diallyldimethylammonium) (TFSI), poly(1-aryl-3-methylimidazolium (trifluoromethanesulfonyl)imide, or poly((N-Methyl-N-propylpiperidinium bis(trifluoromethanesulfonyl)imide), or the like.

The PIL may include, for example, at least one ionically conductive repeating unit of an ether-based monomer, an acryl-based monomer, a methacryl-based monomer, or a siloxane-based monomer.

The PIL may include, for example, at least one of poly(ethylene oxide) (PEO), polyvinyl alcohol (PVA), polyvinylpyrrolidone (PVP), polysulfone, polypropylene oxide (PPO), poly(methyl methacrylate), poly(ethyl methacrylate), poly(dimethyl siloxane), poly(acrylic acid), polymethacrylate, polymethylacrylate, polyethylacrylate, poly(2-ethylhexyl acrylate), poly(butylmethacrylate), poly(2-ethylhexylmethacrylate), poly(decylacrylate), poly(ethylene vinyl acetate), a phosphoric acid ether polymer, polyesther sulfide, a poly(vinylidene fluoride) (PVdF), or a Li-substituted Nafion, and the like, but is not limited thereto. Any suitable material available as the PIL in the art may be used.

The electronically conducting polymer may be, for example, a polyphenylene derivative, a polythiophene derivative, or the like, but is not limited thereto. Any suitable material available as the electronically conducting polymer in the art may be used.

The gel electrolyte gel electrolyte may be, for example, obtained by additionally adding a low-molecular weight solvent to the solid electrolyte that is disposed between the cathode and the anode. The gel electrolyte may be, for example, obtained by adding a solvent, such as a low-molecular weight organic compound, which is a solvent, or an oligomer to the polymer.

The liquid electrolyte may include a solvent and a lithium salt.

The solvent may include at least one of an organic solvent, ionically conductive liquid, and an oligomer, but is not limited thereto. Any suitable material that is liquid at room temperature (25° C.) and available as the solvent in the art may be used.

The organic solvent may include, for example, an ether-based solvent, a carbonate-based solvent, an ester-based solvent, and a ketone-based solvent. The organic solvent may include, for example, at least one of propylene carbonate, ethylene carbonate, fluoroethylene carbonate, vinylethylene carbonate, butylene carbonate, dimethyl carbonate, diethyl carbonate, methylethyl carbonate, methylpropyl carbonate, ethylpropyl carbonate, methylisopropyl carbonate, dipropyl carbonate, dibutyl carbonate, benzonitrile, acetonitrile, tetrahydrofuran, 2-methyltetrahydrofuran, γ-butyrolactone, dioxolane, 4-methyldioxolane, dimethyl acetamide, dimethyl sulfoxide, dioxane, 1,2-dimethoxyethane, sulfolane, dichloroethane, chlorobenzene, nitrobenzene, succinonitrile, diethylene glycol dimethyl ether (DEGDME), tetraethylene glycol dimethyl ether (TEGDME), polyethylene glycol dimethyl ether (PEGDME, Mn=˜500), dimethyl ether, diethyl ether, dibutyl ether, dimethoxy ethane, 2-methyltetrahydrofuran, or tetrahydrofuran, but is not limited thereto. Any suitable material that is liquid at room temperature and available as the organic solvent in the art may be used.

The ionic liquid (IL) may contain, for example, i) at least one cation of an ammonium-based cation, a pyrrolidinium-based cation, a pyridinium-based cation, a pyrimidinium-based cation, an imidazolium-based cation, a piperidinium-based cation, a pyrazolium-based cation, an oxazolium-based cation, a pyridazinium-based cation, a phosphonium-based cation, a sulfonium-based cation, or a triazole-based cation and ii) at least one anion of BF₄⁻, PF₆⁻, AsF₆⁻, SbF₆⁻, AlCl₄⁻, HSO₄⁻, ClO₄⁻, CH₃SO₃⁻, CF₃CO₂⁻, N(CF₃SO₂)₂⁻, Cl⁻, Br⁻, I⁻, SO₄⁻, CF₃SO₃⁻, N(C₂F₅SO₂)₂⁻, N(C₂F₅SO₂)(CF₃SO₂)⁻, NO₃⁻, Al₂Cl₇⁻, CF₃COO⁻, CH₃COO⁻, CF₃SO₃⁻, (CF₃SO₂)₃C⁻, N(CF₃CF₂SO₂)₂⁻, (CF₃)₂PF₄⁻, (CF₃)₃PF₃⁻, (CF₃)₄PF₂⁻, (CF₃)₅PF⁻, (CF₃)₆P⁻, SF₅CF₂SO₃⁻, SF₅CHFCF₂SO₃⁻, CF₃CF₂(CF₃)₂CO⁻, (CF₃SO₂)₂CH⁻, (SF₅)₃C⁻, or (O(CF₃)₂C₂(CF₃)₂O)₂PO⁻.

The lithium salt may include at least one of LiTFSI, LiPF₆, LiBF₄, LiAsF₆, LiClO₄, LiNO₃, (lithium bis(oxalato) borate(LiBOB), LiCF₃SO₃, LiN(SO₂CF₃)₂, LiN(SO₂C₂F₅)₂, LiC(SO₂CF₃)₃, LiN(SO₃CF₃)₂, LiC₄F₉SO₃, LiAlCl₄, and lithium trifluoromethanesulfonate (LiTfO), but is not limited thereto. Any suitable material available as the lithium salt in the art may be used. Here, a concentration of the lithium salt may be in a range of about 0.01 M to about 5.0 M.

The lithium air battery may further include a separator between the cathode and the anode. For use as the separator, any suitable material having a composition that withstands the usage range of the lithium air battery may be used without limitation. The separator may include, for example, a polypropylene non-woven fabric or a polyphenylene sulfide non-woven polymer, a polyethylene or polypropylene olefin-based resin porous film, a glass fiber, and the like, and two or more of the forgoing may be used in combination.

The electrolyte layer may have, for example, a structure in which a solid polymer electrolyte is impregnated with the separator or a structure in which a liquid electrolyte is impregnated with the separator. The electrolyte layer in which a solid polymer electrolyte is impregnated with the separator may be prepared by, for example, arranging a solid polymer electrolyte on one surface or both surfaces of the separator, and then, rolling the separator at the same time. The electrolyte layer in which a liquid electrolyte is impregnated with the separator may be prepared by, for example, injecting a lithium salt-containing liquid electrolyte to the separator.

The lithium air battery of the present disclosure may be manufactured according to methods well known in the art.

For example, the lithium air battery includes the anode on one side of a battery case, the electrolyte layer on the anode, the cathode on the electrolyte layer, the porous cathode current collector on the cathode, and a pressing member on the porous cathode current collector, wherein the pressing member is capable of transferring air to the air electrode, and then, the pressing member is pressed to fix the battery, thereby completing the preparation of the lithium air battery. Here, the battery case may be separated into an upper portion where the anode contacts and a lower portion where the air electrode contacts, and an insulating resin may be disposed between the upper portion and the lower portion, so as to electrically insulate the cathode and the anode.

The lithium air battery may be used for both a primary battery and a secondary battery. A shape of the lithium air battery is not particularly limited, and may be, for example, a coin type, a button type, a sheet type, a lamination type, a cylindrical type, a flat type, a horn type, and the like. The lithium air battery may be also applicable to medium-large batteries for electric vehicles.

FIG. 7 is a schematic diagram showing a structure of a lithium air battery 500 according to an embodiment. In the lithium air battery 500, a first electrolyte layer 400 is disposed between a cathode 200 on a first current collector 210 and an anode 300 on a second current collector 310, wherein the cathode 200 uses ambient oxygen as an activation material and the anode 300 includes lithium. The first electrolyte layer 400 may be a separator impregnated with liquid electrolyte. A second electrolyte layer 450 is disposed between the cathode 200 and the first electrolyte layer 400. The second electrolyte layer 450 may be a ionically conducting lithium solid electrolyte film. The first current collector 210, which is porous, may also serve as a gas diffusion layer capable of diffusing air. A pressing member 220 capable of transferring air to the cathode is disposed on the first current collector 210. A case 320 made of an insulating resin is disposed between the cathode 200 and the anode 300, so as to electrically separate the cathode 200 from the anode 300. Air is supplied to an air inlet 230a, and is discharged to an air outlet 230b. The lithium air battery 500 may be housed in a stainless steel container.

The term “air” as used with respect to the lithium air battery is not limited to the atmosphere, but may refer to pure oxygen gas or a combination of gases containing oxygen. Considering such a broad definition of the term “air”, this term may be used for all applications, such as an air battery, an air electrode, and the like.

Hereinafter, embodiments will now be described more fully with reference to Examples and Comparative Examples below. However, Examples shown and described herein are illustrative examples of embodiments and are not intended to otherwise limit the scope of embodiments in any way.

### EXAMPLES

### Manufacturing Example 1: Manufacture of Perovskite Material (Li_{0.34}La_{0.55}RuO₃)

Li₂CO₃, La₂O₃, and RuO₂ powders were added adjusted to the composition ratio of Li_{0.34}La_{0.55}RuO₃, and then, added to ethanol to be mixed together. Here, an amount of the ethanol was about 4 parts by weight based on 100 parts by weight of the total weights of the Li₂CO₃, La₂O₃, and RuO₂ powders.

The mixture was put in a ball-milling apparatus, followed by being pulverized and mixed for 4 hours. The resultant mixture was dried and heated to a temperature of 800° C. at a heating speed of about 5° C./min. At the same temperature, a process of first heat treatment was performed thereon in an air atmosphere for 4 hours.

The powder obtained by the first heat treatment was ground, so as to prepare a powder of which a primary particle diameter was about 0.3 μm. The prepared powder was pressurized to prepare a cylindrical pellet having a diameter of about 1.3 cm, a height of about 0.5 cm, and a weight of about 0.3 g. A process of second heat treatment was performed on the prepared pellet in an air atmosphere at a temperature of 1,100° C. for 24 hours, so as to obtain a target product. When the temperature was raised to 1,100° C. to proceed the second heat treatment, a heating speed was about 5° C./min. The obtained target product, i.e., a lithium-containing metal oxide, had a composition of Li_{0.34}La_{0.55}RuO₃.

### Example 1: Preparation of Lithium Air Battery

For use as an anode, a an anode protection membrane which was formed by impregnating a Celagard separator impregnated with a PEGDME solution (polyethylene glycol dimethyl ether+1 M LiTFSI) was disposed on a lithium metal foil (thickness of 30 μm, Honjo Metal, Japan). Then, a lithium aluminum titanium phosphate (LATP) membrane, which is a solid electrolyte membrane, (thickness of 180 μm, Ohara Corp., Japan) was disposed on the anode protection membrane.

Li_{0.34}La_{0.55}RuO₃ prepared in Manufacturing Example 1 was pulverized, and then, 0.5 g of powder obtained therefrom (specific surface area: 20 m²/g), 0.21 g of polyvinyl butyral binder (Butvar B-79, available from Solutia Company), and 2 g of ethanol were mixed in a mortar. The mixture was coated on a PET substrate, and dried at room temperature for 1 hour. The dried product was cut with a diameter of 12 mm, and disposed on the LATP film. The resulting film was heated at a temperature of up to 850° C., slowly cooled to room temperature, and sintered, thereby preparing a cathode mixed conductor, i.e., a Li_{0.34}La_{0.55}RuO₃ cathode. Here, a binder was decomposed. After being sintered, the Li_{0.34}La_{0.55}RuO₃ cathode had a thickness of 10 μm and a weight of 1 mg/cm².

For use as an additive, 1-ethyl-3-methylimidazolium bis(trifluoromethanesulfonyl)imide (EM) at an amount of 2 weight % based on the total weight of the cathode mixed conductor was diluted with acetonitrile at an amount in a range of 5 weight % to 10 weight %, and the diluted mixed solution was doped on the cathode mixed conductor, and dried at room temperature for 10 minutes, thereby preparing a cathode in which the additive was mixed.

A gas diffusion layer (GDL, available from SGL Company, 25BC) was disposed on an upper portion of the cathode, a nickel mesh was disposed on the GDL, and a pressing member was disposed on the nickel mesh, wherein the pressing member is capable of transferring air to the cathode. Then, the pressing member was pressed to fix the battery, thereby completing the preparation of the lithium air battery.

### Example 2

A lithium air battery was prepared in the same manner as in Example 1, except that an amount of the additive, EM, used in the preparation of the cathode was 5 weight %, based on the total weight of the cathode mixed conductor.

### Example 3

A lithium air battery was prepared in the same manner as in Example 1, except that an amount of the additive, EM, used in the preparation of the cathode was 30 weight %, based on the total weight of the cathode mixed conductor.

### Example 4

A lithium air battery was prepared in the same manner as in Example 1, except that N-methyl-N-propylpiperidinium bis(trifluoromethanesulfonyl)imide (PP) was used at an amount of 5 weight % based on the total weight of the cathode mixed conductor.

### Comparative Example 1

A lithium air battery was prepared in the same manner as in Example 1, except that an additive was not used.

### Comparative Example 2

A lithium air battery was prepared in the same manner as in Example 1, except that a Pt metal was used instead of EM and that the Pt metal was coated on the cathode to a thickness of 5 nm (about 0.05 weight %) according to a sputtering method.

### Evaluation Example 1: Evaluation of Discharge Capacity

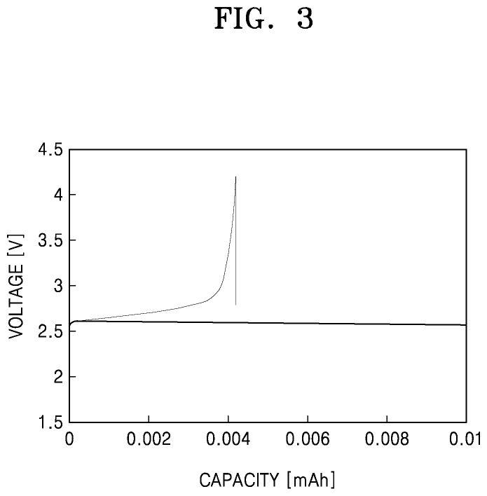

In the oxygen atmosphere (1 atm) at a temperature of 60° C., the lithium air batteries prepared according to Comparative Examples 1 and 2 were each discharged with a constant current of 0.001 mA/cm² until a voltage reached 2.4 V (vs. Li). The discharge capacity was measured, and the results are shown in FIG. 3 and Table 1.

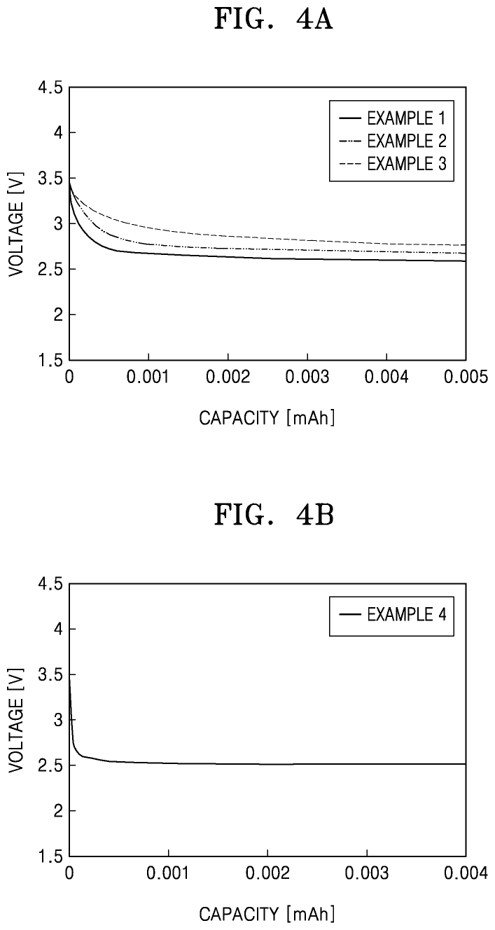

In the oxygen atmosphere (1 atm) at a temperature of 60° C., the lithium air batteries prepared according to Examples 1 to 3 were each discharged with a constant current of 0.001 mA/cm² until a voltage reached 2.4 V (vs. Li). The discharge capacity was measured, and the results are shown in FIG. 4A and Table 1.

In the oxygen atmosphere (1 atm) at a temperature of 60° C., the lithium air battery prepared according to Example 4 was discharged with a constant current of 0.001 mA/cm² until a voltage reached 2.4 V (vs. Li). The discharge capacity was measured, and the results are shown in FIG. 4B and Table 1.

TABLE 1

| | Discharge capacity |
|---|---|
| | (μAh) |
| Example 1 | 3.8 |
| Example 2 | 4.0 |
| Example 3 | 4.6 |
| Example 4 | 1.5 |
| Comparative | Not measurable (0) |
| Example 1 | |
| Comparative | Not measurable (0) |
| Example 2 | |

Referring to FIGS. 3, 4A, and 4B and Table 1, it was confirmed that the discharge capacity was not able to be measured by using the lithium air battery of Comparative Example 1, in which no additive was used and only the mixed conductor was used, and the lithium air battery of Comparative Example 2, in which the Pt metal was used as the additive. It is considered that such failure in the discharge capacity measurement was due to insufficient dissolution of oxygen, making the charging/discharging reaction difficult.

On the other hand, when preparing the lithium air batteries of Examples 1 to 4 in the oxygen atmosphere, it was confirmed that, by dissolving injected oxygen with the additive, the charging/discharging reaction occurred and the discharge capacity was able to be measured.

### Evaluation Example 2: Evaluation of Cycle-Dependent Discharge Voltage/Lifespan

In the oxygen atmosphere (1 atm) at a temperature of 60° C., a charging/discharging cycle was performed on the lithium air batteries of Examples 1 and 3 in a way that each battery was discharged with a constant current of 0.001 mA/cm² until a voltage reached 2.4 V (vs. Li), and then, was charged with the same constant current until a voltage reached 4.2 V.

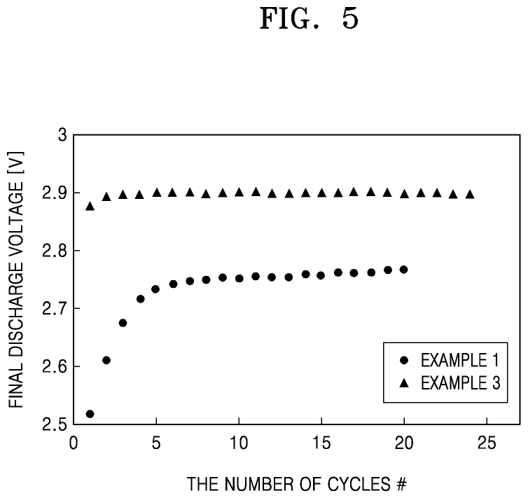

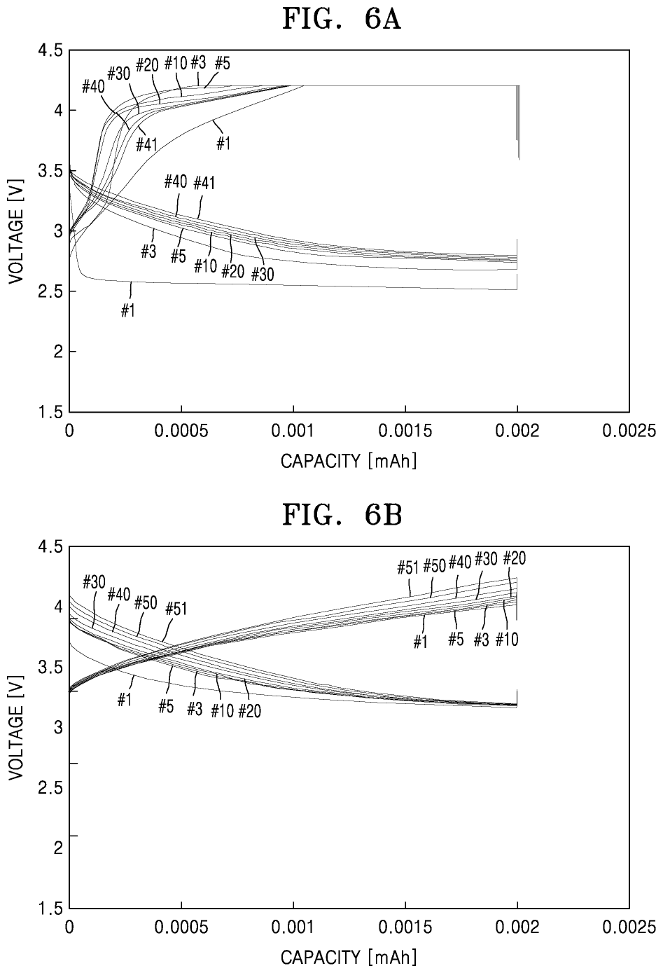

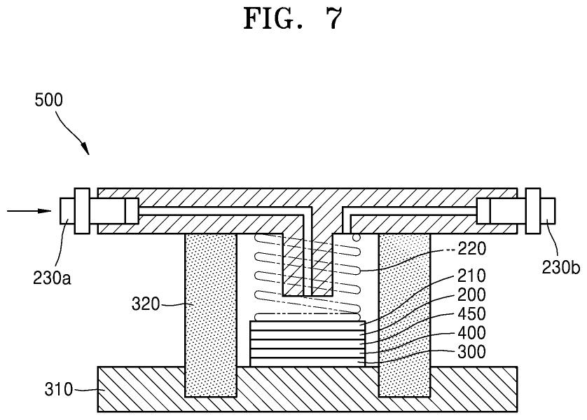

The charging/discharging cycle was repeated for each lithium air battery, and the charge voltage for each cycle and the cycle lifespan were measured. The results are shown in FIGS. 5 and 6.

Referring to FIGS. 5 and 6, it was confirmed that the lithium air battery of Example 3 including the additive at a relatively high amount showed a relatively high discharge voltage compared to that of the lithium air battery of Example 1. It was also confirmed that the lithium air batteries of Examples 1 and 3 both showed improved cycle lifespan.

According to the embodiment, when an additive having a boiling point of 200° C. or higher is used in addition to a cathode mixed conductor, a cathode may have improved electronic conductivity and ionic conductivity as well as improved discharge capacity and lifespan characteristics of a lithium air battery including the cathode.

It should be understood that embodiments described herein should be considered in a descriptive sense only and not for purposes of limitation. Descriptions of features or aspects within each embodiment should be considered as available for other similar features or aspects.

While an embodiment has been described with reference to the figures, it will be understood by those of ordinary skill in the art that various changes in form and details may be made therein without departing from the spirit and scope as defined by the following claims.

What is claimed is:

1. A cathode configured to use oxygen as a cathode active material, the cathode comprising:
a cathode mixed conductor; and
an additive disposed on the cathode mixed conductor and having a boiling temperature of about 200° C. or higher.

2. The cathode of claim 1, wherein the cathode mixed conductor and the additive are in the form of a composite having a core-shell structure in which a core of the core-shell structure comprises the cathode mixed conductor and a shell of the core-shell structure comprises the additive.

3. The cathode of claim 2, wherein the shell in the composite with the core-shell structure has a thickness in a range of about 1 nanometer to about 100 nanometers.

4. The cathode of claim 1, wherein the additive has a boiling temperature in a range of about 200° C. to about 500° C.

5. The cathode of claim 1, wherein the additive has a viscosity in a range of about 5 centipoise to about 200 centipoise.

6. The cathode of claim 1, wherein the additive is a C11 to C20 fluorinated organic compound.

7. The cathode of claim 1, wherein the additive is at least one of 1-ethyl-3-methylimidazolium bis(trifluoromethanesulfonyl)imide, N-methyl-N-propylpiperidinium bis(trifluoromethanesulfonyl)imide, N-diethyl-N-methyl-N-(2-methoxyethyl)ammonium, N-butyl-N-methylpyrrolidinium, or bis(trifluoromethanesulfonyl)amid.

8. The cathode of claim 1, wherein the additive comprises polydimethylsiloxane.

9. The cathode of claim 1, wherein the additive is contained in an amount of about 0.01 weight percent to about 50 weight percent, based on a total weight of the cathode.

10. The cathode of claim 1, wherein the cathode mixed conductor has a specific surface area in a range of about 1 square meters per gram to about 100 square meters per gram.

11. The cathode of claim 1, wherein the cathode mixed conductor comprises lithium.

12. The cathode of claim 1, wherein the cathode mixed conductor has a lithium-ion conductivity of about 10⁻⁸ Siemens per centimeter to about 10⁻³ Siemens per centimeter.

13. The cathode of claim 1, wherein the cathode mixed conductor comprises at least one of a spinel compound, a perovskite compound, a layered compound, a garnet compound, a NASICON compound, a LISICON compound, a phosphate compound, a tavorite compound, a triplite compound, an anti-perovskite compound, a silicate compound, or a borate compound.

14. The cathode of claim 13, wherein the spinel compound represented by at least one of Formula 1 or Formula 2:
Li_{1±x}M_{2±y}O_{4-δ1} Formula 1
Li_{4±a}M_{5±b}O_{12-δ2} Formula 2
wherein, in Formula 1 and Formula 2,
M is each independently at least one metal element belonging to Groups 2 to 16 of the Periodic Table of Elements, and
in Formula 1 and Formula 2, 0<x<1, 0<y<1, 0≤δ1≤1, 0<a<2, 0.3<b<5, and 0≤δ2≤3.

15. The cathode of claim 14, wherein the spinel compound has an electronic conductivity of about 1.0×10⁻⁸ Siemens per centimeter to about 10⁻¹ Siemens per centimeter, and an ionic conductivity of about 1.0×10⁻⁷ S/cm or greater to about 10⁻³ Siemens per centimeter.

16. The cathode of claim 13, wherein the cathode mixed conductor comprises a perovskite compound represented by Formula 6:
LiₓA_{y}G_{z}O_{3-δ} Formula 6
wherein, in Formula 6, A and G are each independently at least one metal element belonging to Groups 2 to 16 of the Periodic Table of Elements, and
in Formula 6, 0<x<1, 0<y<1, 0<x+y≤1, 0<z≤1.5, and 0≤δ≤1.5.

17. The cathode of claim 16, wherein the perovskite compound has an electronic conductivity of about 1.0×10⁻⁹ Siemens per centimeter to about 10⁻¹ Siemens per centimeter, and an ionic conductivity of 2.0×10⁻⁷ Siemens per centimeter to about 10⁻³ Siemens per centimeter.

18. The cathode of claim 1, wherein the layered compound is represented by Formula 9, the NASICON compound is represented by Formula 10, the LISICON compound is represented by Formula 11, the garnet compound is represented by Formula 12, the phosphate compound is represented by at least one of Formula 13 or Formula 14, the triplite compound or the tavorite compound are represented by Formula 15, the anti-perovskite compound is represented by Formula 16, the silicate compound is represented by Formula 17, and the borate compound represented by Formula 18:
Li_{1±x}M_{1±y}O_{2±-δ} Formula 9
wherein, in Formula 9,
M is at least one metal element belonging to Groups 2 to 16 of the Periodic Table of Elements, and
in Formula 9, 0<x<0.5, 0<y<1, and 0≤δ≤1,
Li₁₊ₓAₓM₂₋ₓ(XO₄)₃ Formula 10
wherein, in Formula 10, A and M are each independently at least one metal element belonging to Groups 2 to 16 of the Periodic Table of Elements,
in Formula 10, X is As, P, Mo, or S, and in Formula 10, 0<x<1.0,
Li_{8-c}AₐM_{b}O₄ Formula 11
wherein, in Formula 11, A and M are each independently at least one metal element belonging to Groups 2 to 16 of the Periodic Table of Elements,
in Formula 11, c is (ma+nb), wherein m indicates an oxidation number of A, and n indicates an oxidation number of M, and
in Formula 11, 0<x<8, 0<a≤1, and 0≤b≤1,
LiₓA₃M₂O₁₂ Formula 12
in Formula 12, A and M are each independently at least one metal element belonging to Groups 2 to 16 of the Periodic Table of Elements, and
in Formula 12, 3.0≤x≤7.0,
Li_{1±x}MPO₄ Formula 13
Li₂MP₂O₇ Formula 14
wherein, in Formula 13 and in Formula 14, each M is independently at least one metal element belonging to Groups 2 to 16 of the Periodic Table of Elements, and
in Formula 13 and in Formula 14, each x is independently 0≤x≤1.0,
Li_{1±x}M(TO₄)X Formula 15
wherein, in Formula 15, M is at least one metal element belonging to Groups 2 to 16 of the Periodic Table of Elements,
in Formula 15, T is P or S, and X is F, O, or OH, and
in Formula 15, 0≤x≤1.0,
LiₓM_{y}OA Formula 16
wherein, in Formula 16, M is at least one metal element belonging to Groups 2 to 16 of the Periodic Table of Elements,
in Formula 16, A is F, Cl, Br, I, S, Se, or Te, and
in Formula 16, 2.0≤x≤3.0 and 0≤y≤1.0,
Li_{2±x}MSiO₄ Formula 17
wherein, in Formula 17,
in Formula 16, M is at least one metal element belonging to Groups 2 to 16 of the Periodic Table of Elements, and
in Formula 17, 0≤x≤1.0, and
Li_{1±x}MBO₃ Formula 18
wherein, in Formula 18,
in Formula 18, M is at least one metal element belonging to Groups 2 to 16 of the Periodic Table of Elements, and
in Formula 18, 0≤x≤1.0.

19. The cathode of claim 1, wherein the cathode mixed conductor is not oxidized in air at a potential of 2 volts to 4.2 volts versus Li/Li⁺.

20. A lithium air battery comprising:
the cathode of claim 1;
an anode comprising lithium; and
an electrolyte between the cathode and the anode.

21. The lithium air battery of claim 20, wherein the electrolyte comprises a solid electrolyte.
